(19) United States
(12) Patent Application Publication
(10) Pub. No.: US 2026/0223030 A1
(43) Pub. Date: Jul. 30, 2026

(54) PHASE COHERENT TDW FOR SENSING REFERENCE SIGNAL

(71) Applicant: QUALCOMM Incorporated, San Diego, CA (US)

(72) Inventors: Kexin XIAO, Shanghai (CN); Weimin DUAN, San Diego, CA (US); Hung Dinh LY, San Diego, CA (US)

(21) Appl. No.: 19/145,804

(22) PCT Filed: Feb. 8, 2023
(86) PCT No.: PCT/CN2023/074929

§ 371 Date: Jul. 3, 2025

(51) Int. Cl. H04W 56/00; H04W 24/08

(52) U.S. Cl. CPC H04W 56/0035; H04W 24/08

(57) ABSTRACT

A method of wireless communication at a UE is disclosed herein. The method includes obtaining a configuration that indicates at least one time window associated with at least one of sensing or communications during which phase coherency is to be maintained. The method includes transmitting or receiving an indication of whether the UE is able to maintain the phase coherency during the at least one time window associated with at least one of the sensing or the communications or whether a network node is able to maintain the phase coherency during the at least one time window associated with at least one of the sensing or the communications, respectively.

### TECHNICAL FIELD

The present disclosure relates generally to communication systems, and more particularly, to phase coherency and sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus includes a memory; and at least one processor coupled to the memory and, based at least in part on information stored in the memory, the at least one processor is configured to obtain a configuration that indicates at least one time window associated with at least one of sensing or communications during which phase coherency is to be maintained; and transmit or receive an indication of whether the UE is able to maintain the phase coherency during the at least one time window associated with at least one of the sensing or the communications or whether a network node is able to maintain the phase coherency during the at least one time window associated with at least one of the sensing or the communications, respectively.

In an aspect of the disclosure, a method, a computer-readable medium, and an apparatus for wireless communication at a network node are provided. The apparatus includes a memory; and at least one processor coupled to the memory and, based at least in part on information stored in the memory, the at least one processor is configured to transmit, for a user equipment (UE), a configuration that indicates at least one time window associated with at least one of sensing or communications during which phase coherency is to be maintained; and transmit or receive an indication of whether the network node is able to maintain the phase coherency during the at least one time window associated with at least one of the sensing or the communications or whether the UE is able to maintain the phase coherency during the at least one time window associated with at least one of the sensing or the communications, respectively.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating example aspects of phase coherence and phase incoherence.

FIG. 6 is a diagram illustrating example aspects of reference signals (RSs) for joint communication and sensing.

FIG. 7 is a diagram illustrating example aspects of a positioning reference signal (PRS).

FIG. 8 is a diagram illustrating example aspects of Doppler estimation.

FIG. 9 is a diagram illustrating example aspects of phase coherence time domain windows (TDWs).

FIG. 10 is a diagram illustrating example aspects of sensing measurement windows and phase coherence windows.

FIG. 11 is a diagram illustrating example aspects of TDWs for different types of reference signals.

FIG. 12 is a diagram illustrating example aspects of network based DL cooperative sensing.

FIG. 13 is a diagram illustrating example aspects of UE based UL cooperative sensing.

FIG. 14 is a diagram illustrating example aspects of phase coherence TDWs for UE based UL sensing.

FIG. 15 is a diagram illustrating example communications between a UE and a base station.

FIG. 16 is a flowchart of a method of wireless communication.

FIG. 17 is a flowchart of a method of wireless communication.

FIG. 18 is a diagram illustrating an example of a hardware implementation for an example apparatus.

FIG. 19 is a diagram illustrating an example of a hardware implementation for an example network entity.

### DETAILED DESCRIPTION

Various aspects relate generally to a phase coherent time domain window for a sensing reference signal. Some aspects more specifically may relate to transmitting or receiving an indication as to whether a UE or a network node is able to maintain phase coherency during a time window associated with communications and/or sensing. For example, a wireless communication system may include joint communication and sensing (JCS) capabilities. JCS may refer to an ability of the wireless communication system to perform both wireless communications and sensing (e.g., radar sensing, radio frequency (RF) sensing) simultaneously. For instance, a wireless device equipped with JCS capability may perform sensing to determine aspects of an environment around the wireless device while also communicating with another wireless device (e.g., a base station). A wireless device (e.g., a UE, a base station etc.) may maintain phase continuity in order to perform sensing. If phase continuity is not maintained, sensing performed by the wireless device may be inaccurate and/or the wireless device may not be able to perform the sensing.

In an example, a UE obtains a configuration that indicates at least one time window associated with at least one of sensing or communications during which phase coherency is to be maintained. The UE transmits or receives an indication of whether the UE is able to maintain the phase coherency during the at least one time window associated with at least one of the sensing or the communications or whether a network node is able to maintain the phase coherency during the at least one time window associated with at least one of the sensing or the communications, respectively.

Particular aspects of the subject matter described in this disclosure can be implemented to realize one or more of the following potential advantages. In some examples, by transmitting or receiving the indication as to whether the UE is able to maintain phase coherency during the at least one time window or whether the network node is able to maintain phase coherency during the at least one time window, respectively, the described techniques can be used to facilitate JCS. In one example, if the UE is unable to maintain phase coherency during a time window, the network node may skip a transmission of a sensing reference signal, as a measurement performed on the sensing reference signal may not be accurate due to phase coherency not being maintained by the UE. In another example, if the UE is able to maintain phase coherency during the time window, the network node may transmit a sensing reference signal that may be measured by the UE during the time window while phase coherency is maintained, where the measurement may be used to determine aspects of an environment of the UE. Furthermore, the above-described indication may also facilitate network based DL sensing and/or UE based UL sensing.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

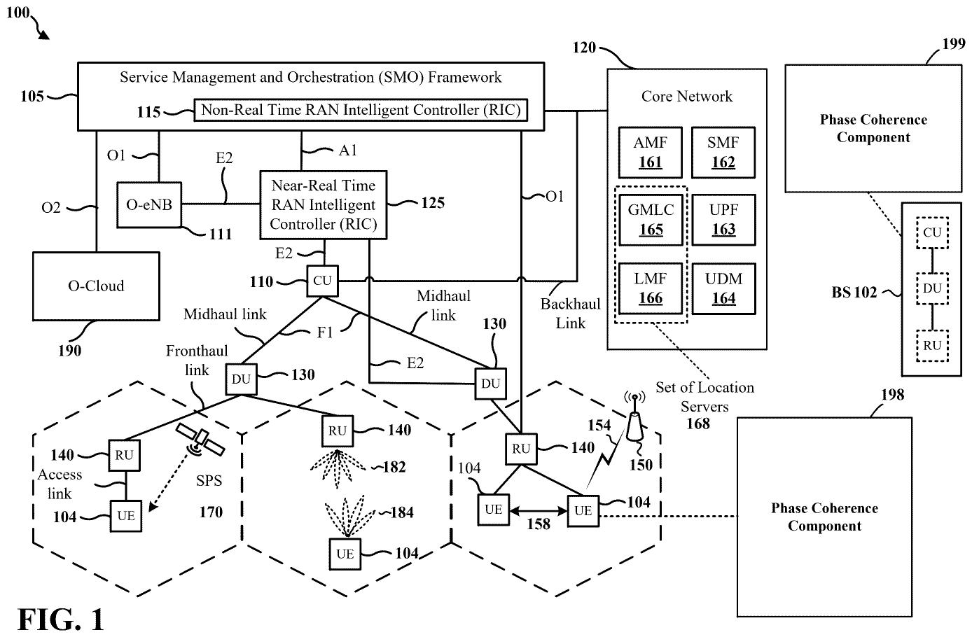

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a phase coherence component 198 that may be configured to obtain a configuration that indicates at least one time window associated with at least one of sensing or communications during which phase coherency is to be maintained; and transmit or receive an indication of whether the UE is able to maintain the phase coherency during the at least one time window associated with at least one of the sensing or the communications or whether a network node is able to maintain the phase coherency during the at least one time window associated with at least one of the sensing or the communications, respectively. In certain aspects, the base station 102 may have a phase coherence component 199 that may be configured to transmit, for a UE, a configuration that indicates at least one time window associated with at least one of sensing or communications during which phase coherency is to be maintained; and transmit or receive an indication of whether the network node is able to maintain the phase coherency during the at least one time window associated with at least one of the sensing or the communications or whether the UE is able to maintain the phase coherency during the at least one time window associated with at least one of the sensing or the communications, respectively. The technologies described herein may generally relate to facilitating the maintenance of phase coherence at UEs and/or network nodes such that the UEs and/or the network nodes are able to perform communications and/or sensing. Although the following description may be focused on 5G NR, the concepts described herein may be applicable to other similar areas, such as LTE, LTE-A, CDMA, GSM, and other wireless technologies.

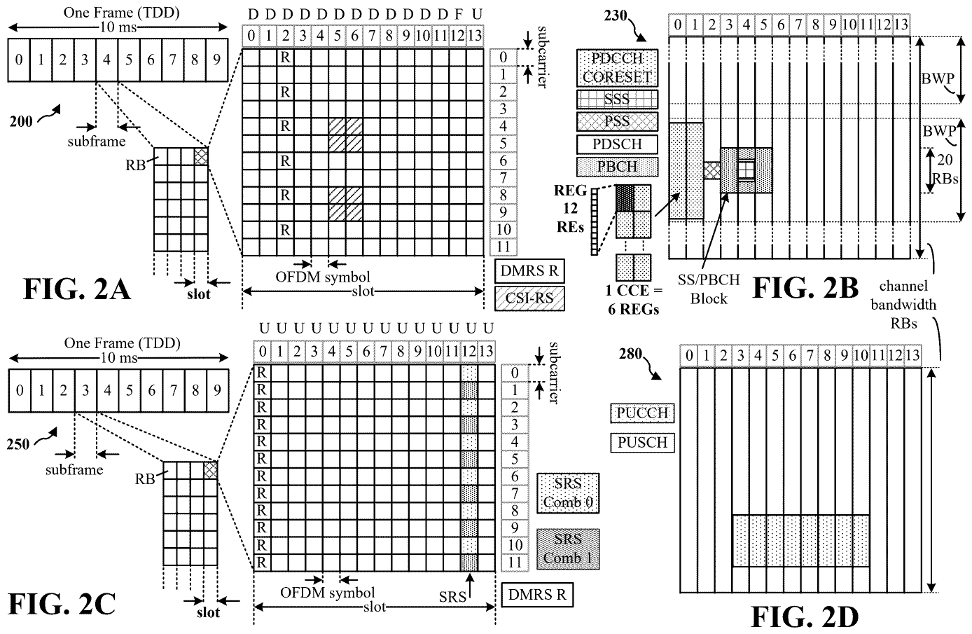

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

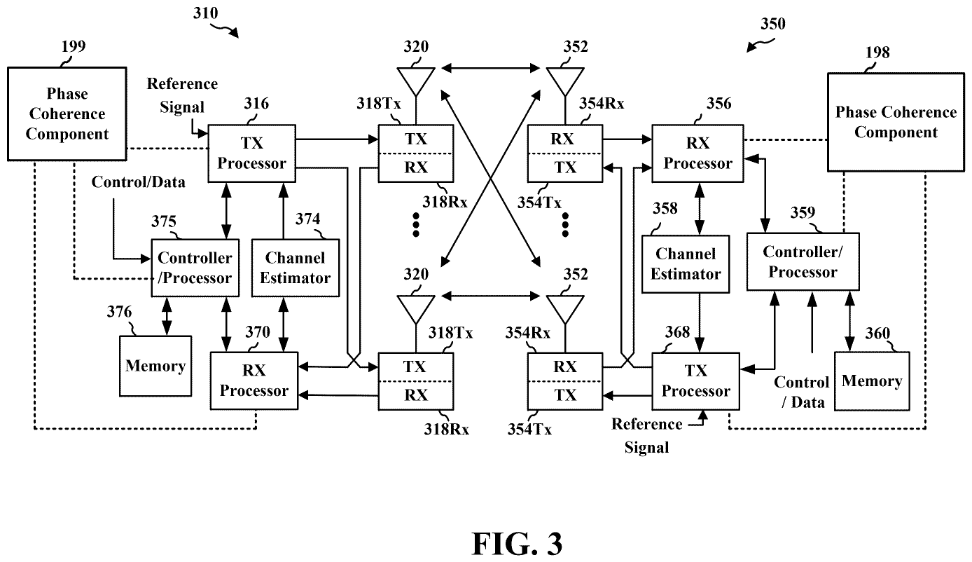

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the phase coherence component 198 of FIG. 1.

At least one of the TX processor 316, the RX processor 370, and the controller/processor 375 may be configured to perform aspects in connection with the phase coherence component 199 of FIG. 1.

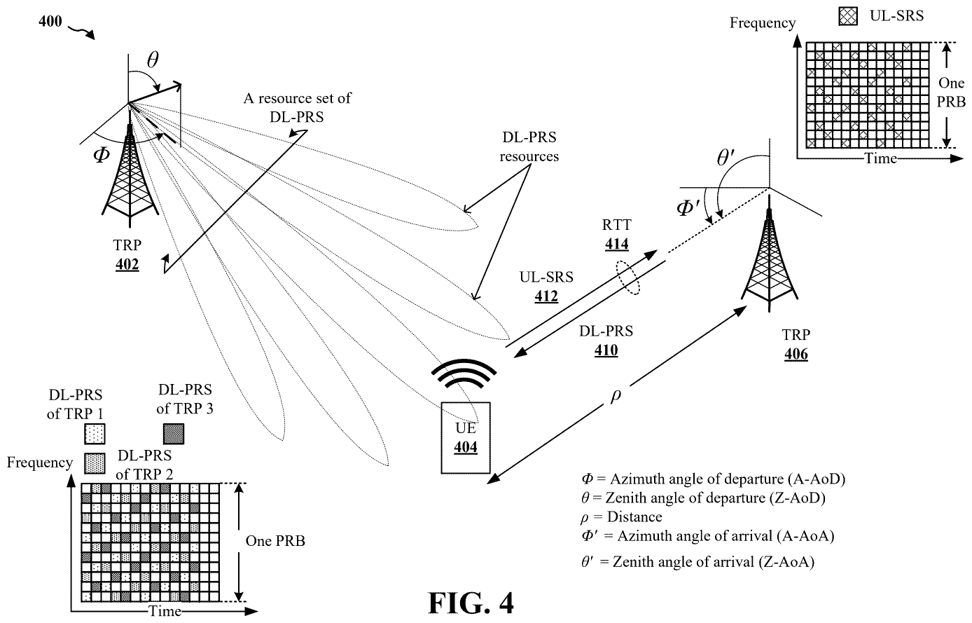

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

A wireless communication system may be equipped with joint communication and sensing (JCS) capability (which may also be referred to as joint communication and radar). JCS may refer to an ability of the wireless communication system to perform both wireless communications and sensing (e.g., radar sensing, radio frequency (RF) sensing) simultaneously. For instance, a wireless device equipped with JCS capability may perform sensing to determine aspects of an environment around the wireless device while also communicating with another wireless device (e.g., a base station). JCS may be useful due to the relatively larger bandwidth allocated for cellular communication systems, such as 5G NR and systems beyond 5G NR, e.g., 6G. For instance, characteristics of 5G NR and systems beyond 5G NR may provide for more use cases for JCS. JCS may provide for a cost-efficient deployment for both radar and communication systems. JCS may provide for mutual performance gains. In one example, sensing information may be used to improve communication link quality (i.e., sensing-assisted communication). For instance, JCS may improve a quality of a Doppler estimation. In another example, sensing information from multiple wireless devices may be used for cooperative sensing (communication-assisted sensing). Table 2 describes use cases for cellular based wide area sensing that may be used in JCS.

TABLE 2
Cellular Based Wide Area RF Sensing Use Cases

| | Maximum | Maximum | | | |
|---|---|---|---|---|---|
| | Range | velocity | Range | Velocity | Angular |
| Use Case | (m) | (m/s) | Resolution | Resolution | Resolution |
| Traffic | 500 | ±50 | Medium | Medium | Low |
| Monitoring | | | | | |
| Identification | 500 | NA | Medium | NA | Medium |
| of parking | | | | | |
| spots | | | | | |
| Road Safety | 100 | ±50 | Medium | Medium | Medium |
| Dynamic 3D | 300 | ±30 | High | High | High |
| maps | | | | | |
| Drone | 500 | ±40 | Medium | High | High |
| monitoring | | | | | |
| and | | | | | |
| management | | | | | |
| Environment | 500 | NA | Medium | NA | NA |
| monitoring | | | | | |

In an example, traffic monitoring referenced above in Table 2 may include determining a number of cars and their respective speeds during a given time period. In an example, identification of parking spots referenced above in Table 2 may include identifying parking spots on busy streets, for example, streets near a beach. In an example, road safety referenced above in Table 2 may include non-line-of-sight (NLOS) object detection, such as around the corner vehicle/pedestrian detection. In another example, road safety referenced above in Table 2 may include detecting pedestrians crossing streets. In an example, dynamic three dimensional (3D) maps referenced above in Table 2 may include sensing information about buildings/roads in a predefined area by multiple UEs and/or base stations (e.g., gNBs). In another example, dynamic 3D maps referenced above in Table 2 may include performing simultaneous localization and mapping (SLAM). In yet another example, dynamic 3D maps referenced above in Table 2 may include reporting information to network authorized equipment for 3D map generation. In an example, environment monitoring referenced above in Table 2 may include weather and/or pollution monitoring. Although the use cases in Table 2 may be outdoor use cases, JCS may also be used in indoor use cases.

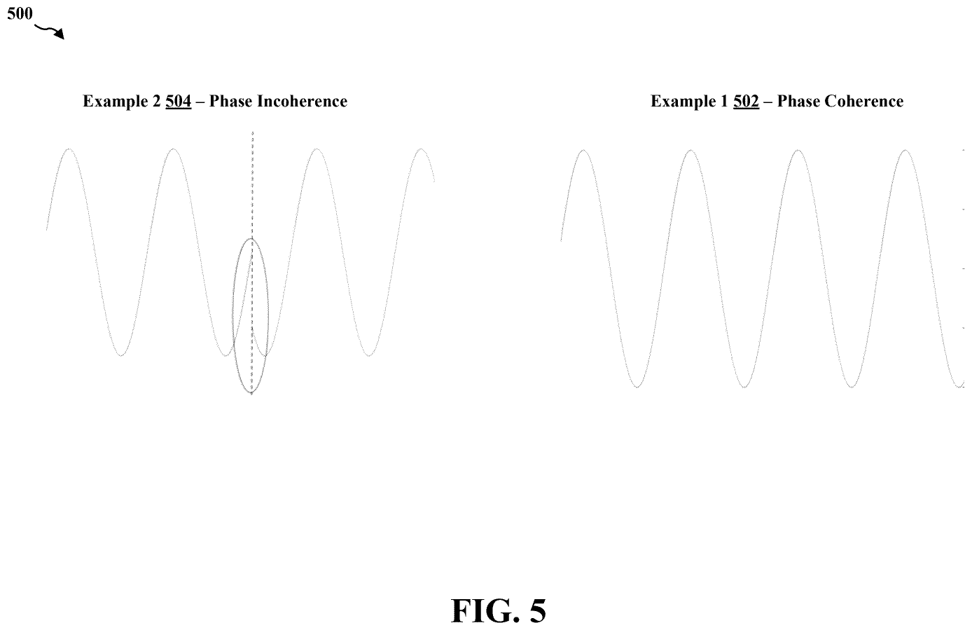

FIG. 5 is a diagram 500 illustrating example aspects of phase coherence (i.e., phase coherency) and phase incoherence (i.e., phase incoherency). Phase coherence may also be referred to as “phase continuity” and phase incoherency may also be referred to as “phase discontinuity.” Phase coherence may refer to a phenomenon where a signal is continuous without a phase jump in a time domain. The diagram 500 includes a first example 502 of phase coherence.

The diagram 500 also includes a second example 504 of phase incoherence. Phase incoherence may refer to a phenomenon where a signal is not continuous (i.e., there is a phase jump in the time domain). Phase incoherence may occur due to various factors. For instance, a change of modulation order may cause phase incoherence, a change of the RB allocation in terms of length and frequency position may cause phase incoherence, a change of a transmission power level of a component carrier (CC) may cause phase incoherence, or UL beam switching for FR2 may cause phase incoherence.

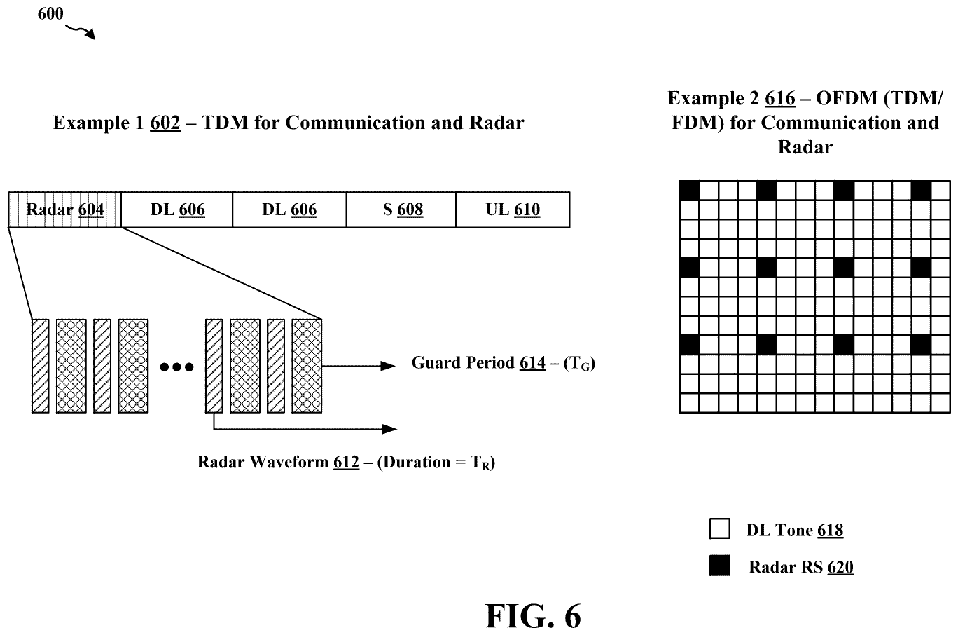

FIG. 6 is a diagram 600 illustrating example aspects of reference signals (RSs) for JCS. RS design for JCS may be important for JCS to function. A waveform of a sensing reference signal (S-RS) used for radar sensing (e.g., frequency-modulated continuous-wave (FMCW)) may be different from a reference signal used in 5G NR. Alternatively, a S-RS may reuse an OFDM waveform.

In a first example 602, time division multiplexing (TDM) may be used for communication and sensing (i.e., for communication and radar). In the first example 602, a radar signal 604 (referred to as “Radar” in FIG. 6), DL transmissions 606 (referred to as “DL” in FIG. 6), a flexible transmission 608 (e.g., either an UL transmission or a DL transmission, referred to as “S” for “special slot” in FIG. 6), and an UL transmission 610 (referred to in FIG. 6 as “UL”) may be time division multiplexed together. The radar signal 604 may include radar waveform(s) 612 and guard period(s) 614, where the radar waveform(s) 612 and the guard period(s) 614 alternate in the radar signal 604. The radar waveform(s) 612 may have a duration T_{R} and the guard period(s) 614 may have a time period T_{G}. In an example, when a target range of the radar signal 604 ranges from 30 m to 300 m, T_{R} and T_{G} may adhere to the following timing relationships: T_{R}<<0.1 μs and T_{G}>1 μs. In some aspects, some DL symbols (slots) may be replaced for radar purposes. In some aspects, different waveforms may be used for communications and radar (i.e., sensing). For instance, FMCW may be used for radar (i.e., sensing) and OFDM may be used for communications. In one aspect, the radar signal 604 may be repeated in order to increase a signal-to-interference-and-noise ratio (SINR).

In a second example 616, OFDM (TDM/frequency division multiplexing (FDM)) may be used for communication and sensing (i.e., for communication and radar). In the second example 616, a DL tone 618 may be multiplexed with a radar RS 620. A design of the radar RS 620 may be based on a range resolution, a velocity resolution, and/or a level of ambiguity of sensing. Range estimation may be associated with a IFFT across a subcarrier dimension. Doppler estimation may be associated with a FFT across multiple symbols.

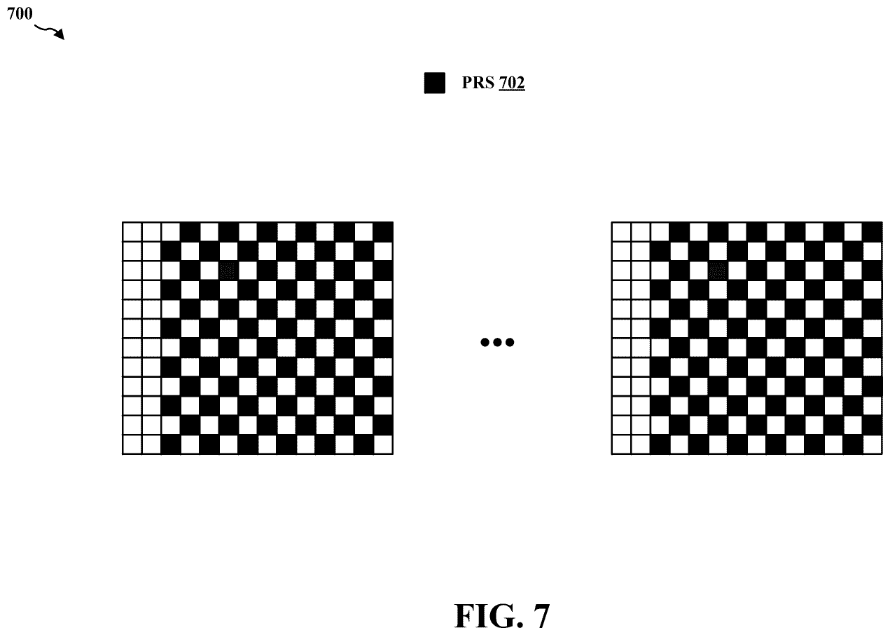

FIG. 7 is a diagram 700 illustrating example aspects of a positioning reference signal (PRS) 702. The PRS 702 may span 2/4/6/12 consecutive symbols with a comb of 2/4/6/12. Resource repetition across multiple slots (N) may be supported. A resource time gap may be configured. Table 3 below details different aspects of sensing capability of NR RSs in different carriers. Table 3 assumes a 12-symbol PRS with N=4 and a gap of zero.

TABLE 3
Sensing Capability of NR RSs in Different Carriers

| f_{c} | 3.5 GHz | | | | 13 GHz | | | |
|---|---|---|---|---|---|---|---|---|
| Δf | 15 | kHz | 30 | kHz | 60 | kHz | 120 | kHz |
| T_{g} | 4.69 | μs | 2.34 | μs | 1.17 | μs | 0.59 | μs |
| W | 50 | MHz | 100 | MHz | 200 | MHz | 400 | MHz |
| T_{B} | 3.853 ms | | 1.927 ms | | 0.963 ms | | 0.482 ms | |
| | (71.35 × 53) | | (35.68 × 54) | | (17.84 × 54) | | (8.92 × 54) | |
| Tₛ | 71.35 | μs | 35.68 | μs | 17.84 | μs | 8.92 | μs |
| fₛ | 15 | kHz | 30 | kHz | 60 | kHz | 120 | kHz |
| dₘₐₓ < cT_{g}/2 | 703.5 | m | 351 | m | 175.9 | m | 87.9 | m |
| Δd > c/(2W) | 3 | m | 1.5 | m | 0.75 | m | 0.38 | m |
| Δv > c/(2f_{c}T_{b}) | 11 | m/s | 22 | m/s | 12 | m/s | 24 | m/s |
| νₘₐₓ < cΔf/ | 64 | m/s | 129 | m/s | 69 | m/s | 138 | m/s |
| (20f_{c}) | | | | | | | | |

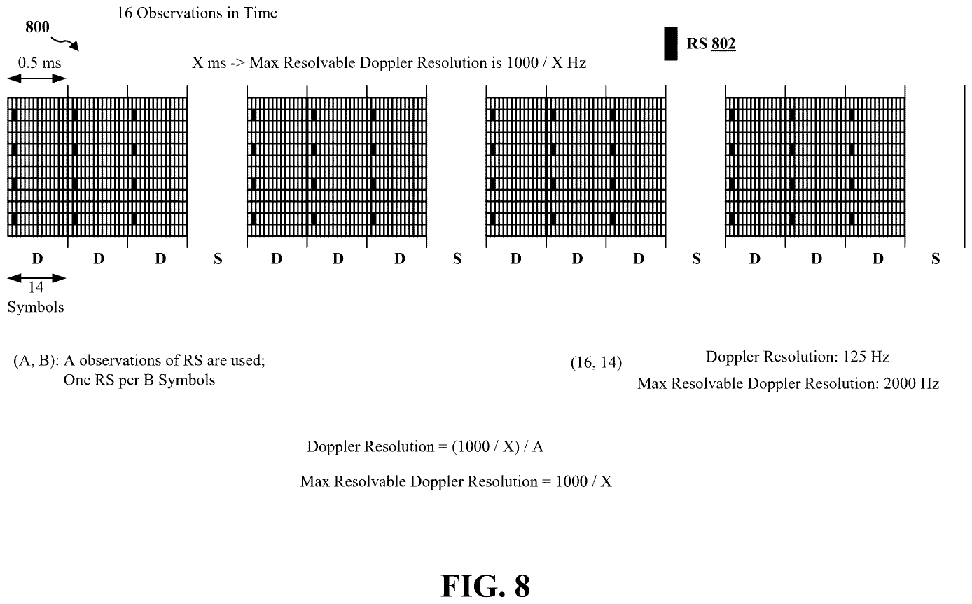

In Table 3 above, Δf may be a subcarrier spacing, T_{g} may be a guard period (e.g., a duration of a carrier phase), W may be a bandwidth, T_{B} may be a duration (i.e., gap) between a first symbol and a last symbol of one PRS (e.g., one PRS may span across one or multiple slots, such as four), Tₛ may refer to a symbol duration, and fₛ may refer to a subcarrier spacing for OFDM for a PRS. Furthermore, in Table 3 above, dₘₐₓ may refer to a maximum operation range for a PRS, Δ_{d} may refer to a range resolution for the PRS, Δᵥ may refer to a velocity resolution for the PRS, Vₘₐₓ may refer to a maximum velocity associated with the PRS, c may refer to the speed of light, and f_{c} may refer to a carrier frequency. With respect to Table 3 above, a range resolution may be smaller than 1 m at 60/120 kHz. Velocity resolution may not be feasible for N=4 (>30 km/h). To achieve an increased velocity resolution, a long PRS repetition may be configured (narrow bandwidth/long duration). To achieve an increased range resolution, a PRS that spans across multiple intra-band CCs may be utilized. When dₘₐₓ is relatively large, an extended cyclic prefix (ECP) for sensing may be utilized. FIG. 8 is a diagram 800 illustrating example aspects of Doppler estimation using a cellular reference signal configuration. Doppler estimation may refer to a technique that detects a velocity of a moving target at a specific range based on a Doppler shift caused by the moving target. The diagram 800 depicts a RS 802 that may be received by a UE (or another wireless device). The RS 802 may be a cellular based RS, such as an OFDM symbol based RS. In the example depicted in the diagram 800, a SCS may be 15 kHz.

“A” observations of the RS 802 may be used for Doppler estimation. In the example depicted in the diagram 800, “A” is 16. Additionally, one RS per “B” symbols may occur. In the example depicted in the diagram 800, “B” is 14. A time period of “X” may be used for Doppler estimation. In the example depicted in the diagram 800, “X” is 0.5 ms. A Doppler resolution and a maximum resolvable Doppler resolution are provided by equations (I) and (II) below, respectively.

$$Doppler Resolution = \frac{\frac{1000}{X}}{A} \qquad ( I )$$

$$Maximum Resolvable Doppler Resolution = \frac{1000}{X} \qquad ( II )$$

Following the example depicted in the diagram 800 and according to equations (I) and (II) above, respectively, the Doppler resolution may be 125 Hz and the maximum resolvable Doppler resolution may be 2000 Hz.

As discussed above, due to the relatively large bandwidth allocated for 5G NR (and potentially for future wireless communication systems), JCS may have more use cases. An OFDM waveform (or a variant of an OFDM waveform) may be used for JCS (i.e., joint communication/RF sensing). For instance, the OFDM waveform may enable band multiplexing with other cellular reference signals and physical (PHY) channels.

In RF sensing, especially for Doppler estimation with a long measurement period, phase continuity (i.e., phase coherence) may be maintained at both a radar transmitter (Tx) and a radar receiver (Rx). Maintaining phase continuity may involve meeting various conditions. A first condition may be ensuring that a modulation order does not change between the radar Tx and the radar Rx. A second condition may be that RB allocation in terms of length and frequency position does not change and that intra-slot and inter-slot frequency hopping is not enabled within a repetition bundle. A third condition may be that there is not a change of a transmission power level of a component carrier (CC), that is, there is no change in a power control parameter specified in a specification and no change when a CC is not impacted by other concurrent CCs that are configured for inter-band carrier aggregation (CA) or dual connectivity (DC) for the same UE with dynamic power sharing and there is no change in any configured CCs that are part of a configured intra-band uplink CA or DC. A fourth condition may be that UL beam switching for FR2 for a UE does not occur. A fifth condition may be that a same transmit precoder matrix indicator (TPMI) precoder is applied across PUSCH transmission. A sixth condition may be that a timing advance (TA) and UE UL timing autonomous adjustment cause a phase to change.

As discussed above, a wireless communication system may include JCS capabilities. JCS may refer to an ability of the wireless communication system to perform both wireless communications and sensing (e.g., radar sensing, radio frequency (RF) sensing) simultaneously. For instance, a wireless device equipped with JCS capability may perform sensing to determine aspects of an environment around the wireless device while also communicating with another wireless device (e.g., a base station). A wireless device (e.g., a UE, a base station etc.) may maintain phase continuity in order to perform sensing. If phase continuity is not maintained, sensing performed by the wireless device may be inaccurate and/or the wireless device may be unable to perform the sensing.

Various technologies pertaining to a time domain window (TDW) for radar reference signal transmission to indicate phase coherency are described herein. The TDW may be a phase coherence TDW for network based DL sensing. The TDW may be configured to recur periodically or the TDW may be configured to occur dynamically. A sensing reference signal (S-RS) dropping rule may be based on Tx and Rx phase coherence capability reporting. The TDW may be a phase coherence TDW for UE based UL sensing. The TDW may be configured to accommodate an event that violates Tx phase coherence.

In an example, a UE obtains a configuration that indicates at least one time window associated with at least one of sensing or communications during which phase coherency is to be maintained. The UE transmits or receives an indication of whether the UE is able to maintain the phase coherency during the at least one time window associated with at least one of the sensing or the communications or whether a network node is able to maintain the phase coherency during the at least one time window associated with at least one of the sensing or the communications, respectively. Vis-à-vis transmitting an indication of whether the UE is able to maintain phase coherency during the at least one time window associated with at least one of the sensing or the communications or whether the network node is able to maintain phase coherency during the at least one time window associated with at least one of the sensing or the communication, the UE and/or the network node may perform subsequent actions that facilitate sensing, such as sensing performed as part of JCS. For instance, if the UE is unable to maintain phase coherency during a time window, a network node may skip a transmission of a sensing reference signal during the time window, as a measurement performed on the sensing reference signal may not be accurate due to phase coherency not being maintained.

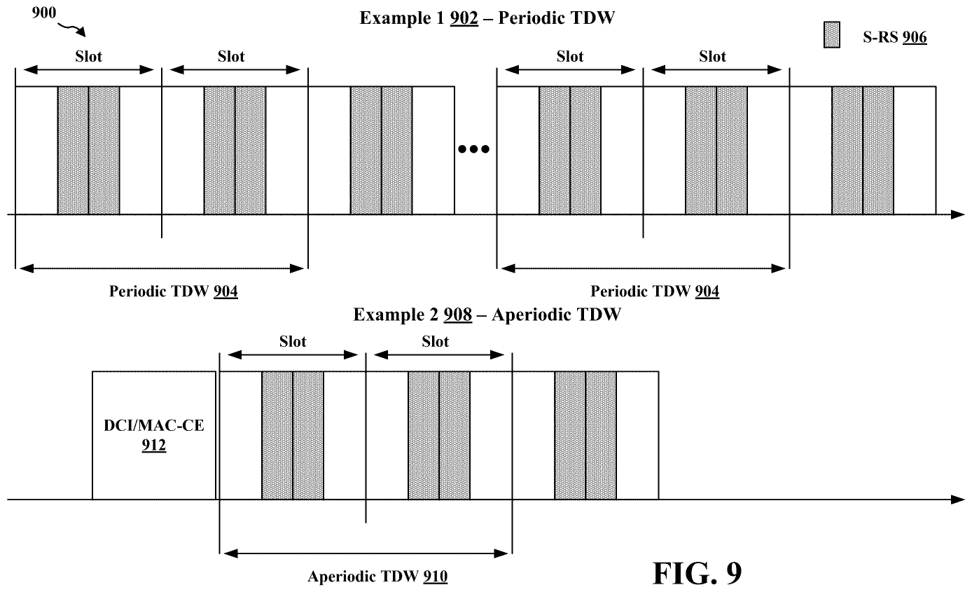

FIG. 9 is a diagram 900 illustrating example aspects of phase coherence TDWs. In an example, a phase coherence TDW may be used for network-based DL sensing. In one aspect, a UE (or another device) that performs sensing may be configured with one or multiple phase coherence TDWs over which phase coherence may be maintained.

In a first example 902, a UE (or another device) may be configured with a periodic TDW 904 that recurs periodically. The periodic TDW 904 may also be referred to as a periodic phase coherence TDW. The UE may maintain (or attempt to maintain) phase coherence during the periodic TDW 904. A periodicity and an offset of the periodic TDW 904 may be configured with respect to a slot, a subframe, or a frame timing. The UE may perform a measurement (e.g., a reference signal received power (RSRP) measurement) on a S-RS 906 (or more than one S-RS) during the periodic TDW 904. In one aspect, a base station may indicate to the UE whether or not the S-RS 906 has phase coherence dynamically (e.g., via a DCI or a medium access control (MAC) control element (MAC-CE)). In another aspect, the base station may indicate to the UE whether or not the S-RS 906 has phase coherence semi-statically (e.g., via RRC signaling or system information (SI)). In an example, if phase non-continuity (i.e., phase incoherency) is indicated to the UE (e.g., via a DCI, a MAC-CE, RRC signaling, or SI), the UE may skip a measurement (e.g., a Doppler related measurement) of the S-RS 906 or ignore another measurement (e.g., a sensing measurement). In the example, the UE may skip (i.e., not transmit) a related measurement report to a network.

In a second example 908, the UE (or another device) may be configured with an aperiodic TDW 910 (or more than one aperiodic TDW) that may be activated when the UE receives a MAC-CE/DCI 912 transmitted by the base station. The aperiodic TDW 910 may also be referred to as an aperiodic phase coherence TDW. The UE may maintain (or attempt to maintain) phase coherence during the aperiodic TDW 910. The UE may perform a measurement (e.g., a RSRP measurement) on the S-RS 906 (or on more than one S-RS) during the aperiodic TDW 910.

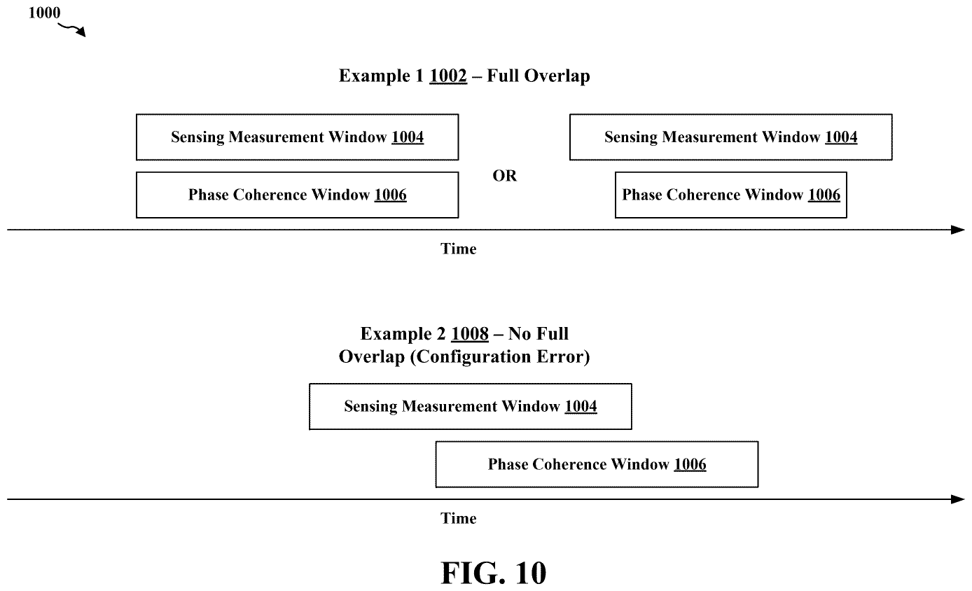

FIG. 10 is a diagram 1000 illustrating example aspects of sensing measurement windows and phase coherence windows. In a first example 1002, a UE (or another device) may be configured with a sensing measurement window 1004 and a phase coherence window 1006. The sensing measurement window 1004 and/or the phase coherence window 1006 may be or include the periodic TDW 904 and/or the aperiodic TDW 910. In an example, the UE may maintain (or attempt to maintain) phase coherence during the phase coherence window 1006 and the UE may perform measurements on one or more reference signals during the sensing measurement window 1004. In the first example 1002, the sensing measurement window 1004 and the phase coherence window 1006 may be configured such that the phase coherence window 1006 is confined within the sensing measurement window 1004. In the first example 1002, the phase coherence window 1006 and the sensing measurement window 1004 may have equal lengths and may fully overlap or the phase coherence window 1006 may have a smaller length/duration than a length/duration of the sensing measurement window 1004. Although not depicted in the first example 1002, the phase coherence window 1006 may include multiple phase coherence windows that are confined within the sensing measurement window 1004.

In a second example 1008, the phase coherence window 1006 may not fully overlap with the sensing measurement window 1004. For instance, all or a portion of the phase coherence window 1006 may occur outside of the sensing measurement window 1004. The sensing measurement window 1004 and/or the phase coherence window 1006 may be or include the periodic TDW 904 and/or the aperiodic TDW 910. In the second example 1008, the phase coherence window 1006 may be considered as a configuration error due to the phase coherence window 1006 not fully overlapping with the sensing measurement window 1004. If the phase coherence window 1006 and the sensing measurement window 1004 are configured for the UE as illustrated in the second example 1008, the UE may determine that the configuration error has occurred and the UE may request a reconfiguration of the phase coherence window 1006 and the sensing measurement window 1004.

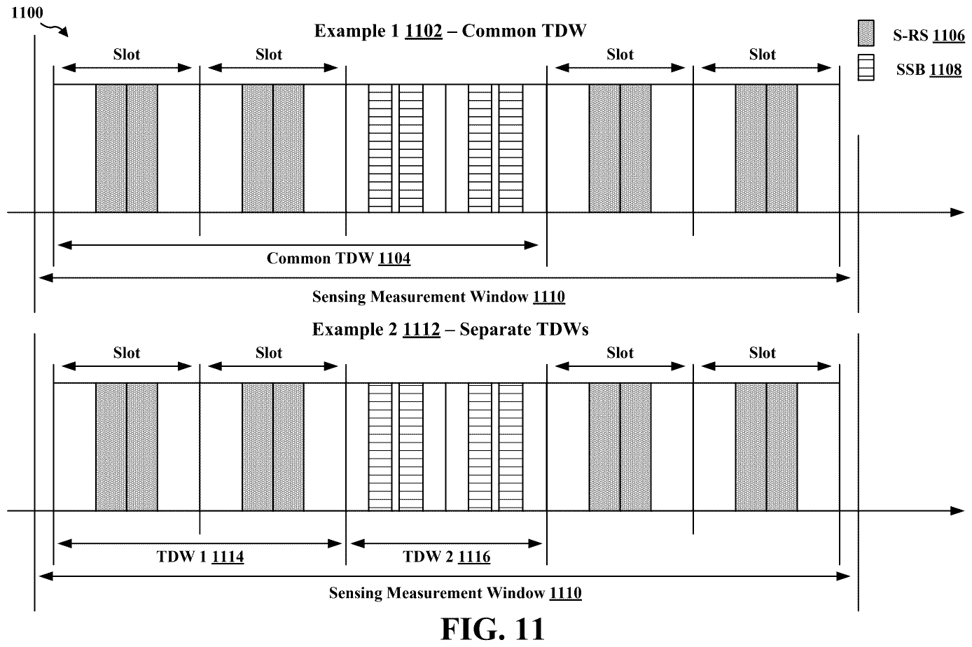

FIG. 11 is a diagram 1100 illustrating example aspects of TDWs for different types of reference signals. In one aspect, multiple types of signals may be utilized within a measurement window for sensing. In an example, the multiple types of signals may include a PRS, a SSB, or a S-RS.

In a first example 1102, a UE (or another device) may be configured with a common TDW 1104 in which multiple types of reference signals for sensing (e.g., a S-RS 1106, a SSB 1108, etc.) may be measured by the UE (or another device). The common TDW 1104 may be confined within a sensing measurement window 1110. The common TDW 1104 may be or include the periodic TDW 904 or the aperiodic TDW 910. The common TDW 1104 may also be or include the phase coherence window 1006 as described above in the first example 1002. The sensing measurement window 1110 may be or include the sensing measurement window 1004 as described above in the first example 1002.

The UE (or another device) may receive an indication from a base station as to which types of signals have phase coherence in the common TDW 1104. In one example, the indication may indicate that the S-RS 1106 and the SSB 1108 have phase coherence during the common TDW 1104. In another example, the indication may indicate that the S-RS 1106 has phase coherence during the common TDW 1104. In yet another example, the indication may indicate that the SSB 1108 has phase coherence during the common TDW 1104. The UE may perform a measurement (e.g., a RSRP measurement) on the S-RS 1106 and/or the SSB 1108 during the common TDW 1104.

In a second example 1112, the UE (or another device) may be configured with separate TDWs for different types of reference signals for sensing. For example, the UE may be configured with a first TDW 1114 for measuring the S-RS 1106 and a second TDW 1116 for measuring the SSB 1108. The first TDW 1114 and the second TDW 1116 may be confined within the sensing measurement window 1110. The first TDW 1114 and/or the second TDW 1116 may be or include the periodic TDW 904 or the aperiodic TDW 910. The first TDW 1114 and/or the second TDW 1116 may also be or include the phase coherence window 1006 as described above in the first example 1002. The sensing measurement window 1110 may be or include the sensing measurement window 1004 as described above in the first example 1002. The UE may perform a first measurement (e.g., a first RSRP measurement) on the S-RS 1106 during the first TDW 1114 and the UE may perform a second measurement (e.g., a RSRP measurement) on the SSB 1108 during the second TDW 1116.

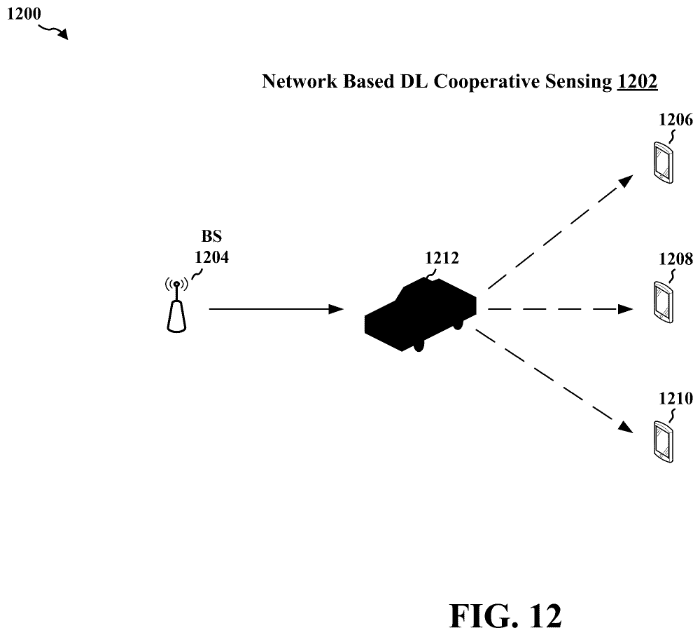

FIG. 12 is a diagram 1200 illustrating example aspects of network based DL cooperative sensing 1202. In order to save network power and to improve spectrum efficiency, a base station 1204 (e.g., a gNB) may drop a sensing reference signal (e.g., a PRS, a SSB, or a S-RS) transmission and/or reschedule a resource associated with the sensing reference signal transmission for another purpose when a threshold number of UEs are unable to maintain Rx phase coherence during a sensing measurement window (e.g., the sensing measurement window 1004, the sensing measurement window 1110, etc.). In an example, the UEs may include a first UE 1206, a second UE 1208, a third UE 1210, and a vehicle 1212 (collectively referred to herein as “the UEs 1206-1212”).

In one aspect with respect to the network based DL cooperative sensing 1202, the UEs 1206-1212 may be configured to measure a sensing reference signal (or sensing reference signals) during a sensing measurement window (i.e., during a configured phase coherence TDW, such as the periodic TDW 904, the aperiodic TDW 910, the phase coherence window 1006, the common TDW 1104, the first TDW 1114, the second TDW 1116, etc.). The UEs 1206-1212 may report their respective capabilities of maintaining phase coherence during the sensing measurement window (i.e., during a configured phase coherence TDW, such as the periodic TDW 904, the aperiodic TDW 910, the phase coherence window 1006, the common TDW 1104, the first TDW 1114, the second TDW 1116, etc.). For instance, the UEs 1206-1212 may transmit indications of their respective capabilities of maintaining phase coherence to the base station 1204. The indications may be referred to as “UE Rx phase coherence reports.”

Based on the UE Rx phase coherence reports (and a threshold number or a threshold percentage), the base station 1204 may determine whether to drop transmission of the sensing reference signal (or the sensing reference signals) to the UEs 1206-1212. For instance, the base station 1204 may transmit indications to the UEs 1206-1212 indicating whether or not the sensing reference signal (or sensing reference signals) will be transmitted. In an example, if some UEs (e.g., the first UE 1206) are not able to maintain Rx phase coherency to receive two separate sensing reference signals, but other UEs (e.g., the second UE 1208, the third UE 1210, and the vehicle 1212) are able to maintain the Rx phase coherency for the sensing reference signal, the base station 1204 may continue transmitting the two separate sensing reference signals. In another example, if most UEs (e.g., the first UE 1206, the second UE 1208, and the vehicle 1212) are not able to maintain RX phase coherency for the sensing reference signal, the base station 1204 may drop the sensing reference signal transmission and/or reschedule a resource originally allocated for the sensing reference signal for another purpose.

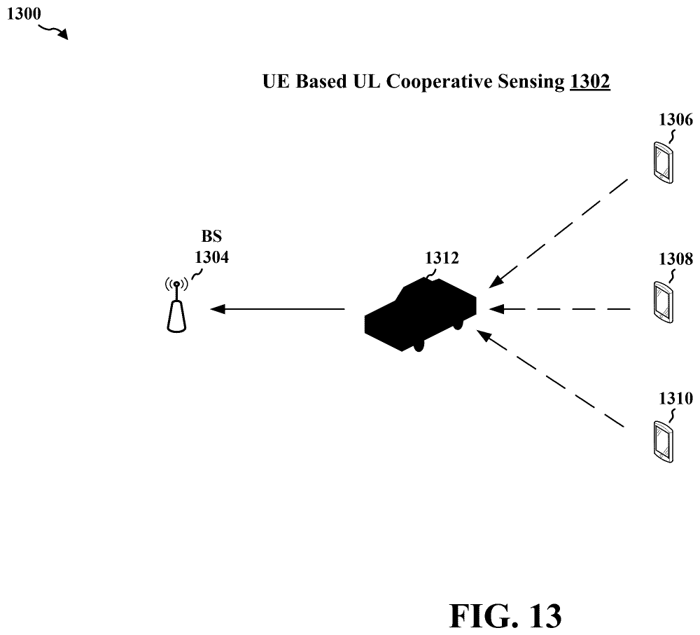

FIG. 13 is a diagram 1300 illustrating example aspects of UE based UL cooperative sensing 1302. For the UE based UL cooperative sensing 1302, a UE may report a maximum duration of a TDW for which the UE is able to maintain Tx phase continuity as UE capability. For instance, the maximum duration may be for the periodic TDW 904, the aperiodic TDW 910, the phase coherence window 1006, the common TDW 1104, the first TDW 1114, the second TDW 1116, etc. In an example, a first UE 1306, a second UE 1308, a third UE 1310, and a vehicle 1312 (collectively referred to herein as “the UEs 1306-1312”) may report their respective maximum durations of TDWs to a base station 1304 (e.g., a gNB). For instance, the UEs 1306-1312 may transmit indications of their respective maximum durations of the TDWs to the base station 1304.

In one aspect with respect to the UE based UL cooperative sensing 1302, the base station 1304 may indicate sensing measurement windows (e.g., phase coherence TDWs, such as the periodic TDW 904, the aperiodic TDW 910, the phase coherence window 1006, the common TDW 1104, the first TDW 1114, the second TDW 1116, etc.) to the UEs 1306-1312 for transmitting UL sensing reference signal(s), where a length of the configured TDWs does not exceed the maximum duration reported (i.e., transmitted) by the UEs 1306-1312.

In another aspect with respect to the UE based UL cooperative sensing 1302, the base station 1304 may dynamically indicate its status of maintaining Rx phase coherence to the UEs 1306-1312 before the UEs 1306-1312 transmit UL sensing reference signals in the configured TDWs. In an example, if the base station 1304 is unable to maintain Rx phase coherency in the configured TDW to receive separate UL sensing reference signals, each of the UEs 1306-1312 may skip their respective transmissions of UL sensing reference signals during an indicated period of the TDW, even if the UEs 1306-1312 are able to maintain Tx phase coherency during the TDW.

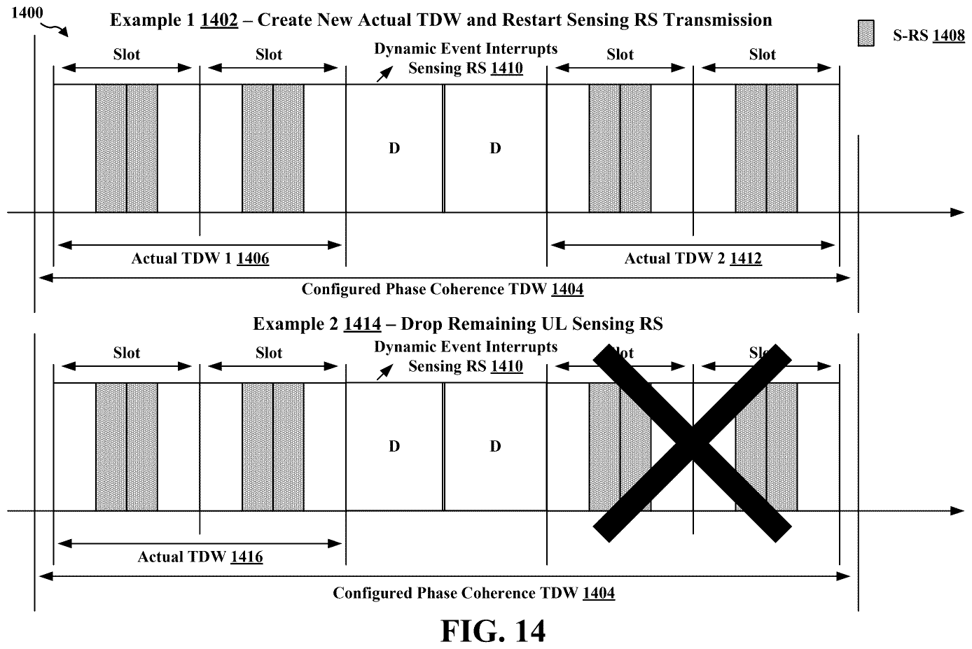

FIG. 14 is a diagram 1400 illustrating example aspects of phase coherence TDWs for UE based UL sensing. Certain events may occur that cause UE Tx phase continuity to be violated. For instance, an event may be a dynamic event, such as a high priority transmission, a reception of a dynamic slot format indicator (SFI), or some other event. Whether or not a UE is able to create a new TDW may be based on a UE capability of supporting restarting sensing RS transmissions.

In a first example 1402, if a UE supports creation of a new actual TDW and if the UE supports restarting UL sensing reference signal transmissions, a base station (e.g., a gNB) may continue reception of remaining UL sensing reference signals. In the first example 1402, the UE may be configured with a configured phase coherence TDW 1404. The configured phase coherence TDW 1404 may include aspects described above in the description of FIGS. 9-13. In a first actual TDW 1406 (based on the configured phase coherence TDW 1404), the UE may transmit a S-RS 1408 (e.g., a UL S-RS). At 1410, an event (e.g., a dynamic event) may occur which may interrupt a transmission of a sensing reference signal (e.g., the S-RS 1408). The UE may create a second actual TDW 1412 based on the occurrence of the event (i.e., based on detecting that the event occurred). The UE may then continue transmitting the S-RS 1408 during the second actual TDW 1412.

In a second example 1414, the UE may not support creating a new actual TDW and the UE may drop transmissions of remaining UL sensing reference signals. In the second example 1414, the UE may be configured with the configured phase coherence TDW 1404. The configured phase coherence TDW 1404 may include aspects described above in the description of FIGS. 9-13. In an actual TDW 1416 (based on the configured phase coherence TDW 1404), the UE may transmit a S-RS 1408 (e.g., a UL S-RS). At 1410, an event (e.g., a dynamic event) may occur which may interrupt a transmission of a sensing reference signal (e.g., the S-RS 1408). The UE may drop transmissions of the S-RS 1408 based on the occurrence of the event (i.e., based on detecting that the event occurred), which is indicated in the second example 1414 by an “X.”

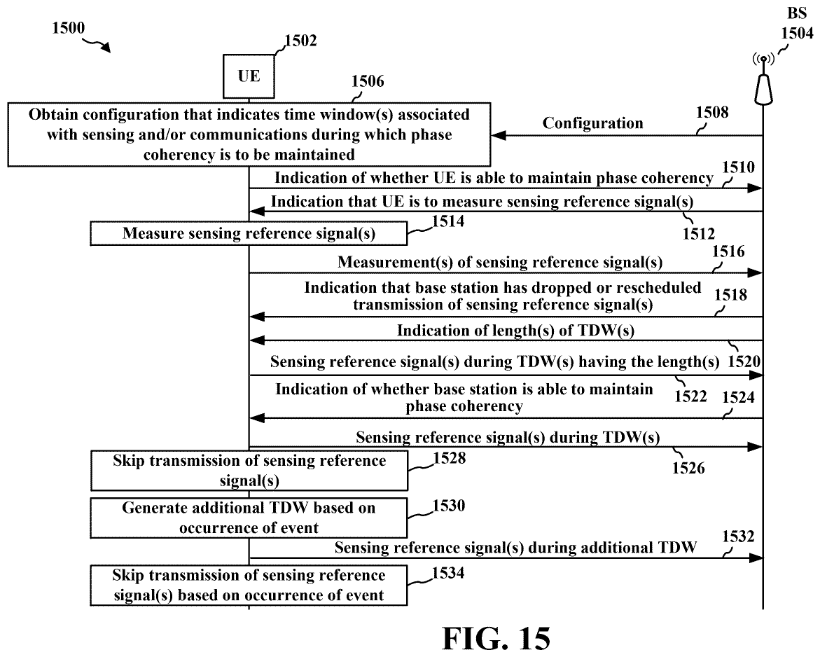

FIG. 15 is a diagram 1500 illustrating example communications between a UE 1502 and a base station 1504. In an example, the UE 1502 may be the UE 104, the UE 350, the UE 404, one of the UEs 1206-1212, or one of the UEs 1306-1312. In an example, the base station 1504 may be the base station 102, the base station 310, the base station 1204, or the base station 1304.

At 1506, the UE 1502 may obtain a configuration that indicates time window(s) associated with sensing and/or communications during which phase coherency is to be maintained. For instance, at 1508, the UE may receive the configuration from the base station 1504. At 1510, the UE 1502 may transmit an indication as to whether the UE 1502 is able to maintain phase coherency during the time window(s).

At 1512, the UE 1502 may receive an indication from the base station 1504 indicating that the UE 1502 is to measure sensing reference signal(s) during TDW(s) if the indication transmitted at 1510 indicates that the UE 1502 is able to maintain phase coherency during the TDW(s) and at 1514, the UE 1502 may measure the sensing reference signal(s) during the TDW(s) while the UE 1502 maintains phase coherency. At 1516, the UE 1502 may transmit measurement(s) of the sensing reference signal(s) to the base station 1504.

At 1518, the UE 1502 may receive an indication from the base station 1504 indicating that the base station 1504 has dropped a transmission of reference signal(s) or the base station 1504 has rescheduled resources associated with the transmission if the indication transmitted at 1510 indicates that the UE 1502 is unable to maintain phase coherency during the TDW(s). At 1520, the UE 1502 may receive an indication from the base station 1504 indicating a length of TDW(s) if the indication transmitted at 1510 indicates a maximum duration during which the UE 1502 is able to maintain a transmission phase continuity (i.e., phase coherency). The length may be less than or equal to the maximum duration. At 1522, the UE 1502 may transmit sensing reference signal(s) during the TDW(s) having the length while the UE 1502 maintains phase coherency.

At 1524, the UE 1502 may receive an indication from the base station 1504 indicating whether the base station 1504 is able to maintain phase coherency during the time window(s). At 1526, the UE 1502 may transmit sensing reference signal(s) during TDW(s) based on the indication received at 1524 if the indication indicates that the base station 1504 is able to maintain phase coherency during TDW(s). At 1528, the UE 1502 may skip a transmission of the sensing reference signal(s) based on the indication received at 1524 if the indication indicates that the base station 1504 is not able to maintain phase coherency during the TDW(s).

At 1530, the UE 1502 may generate additional TDW(s) based on an occurrence of an event. At 1532, the UE 1502 may transmit sensing reference signal(s) during the additional TDW(s) while the UE 1502 maintains phase coherency. At 1534, the UE 1502 may skip transmission(s) of the sensing reference signal(s) based on the occurrence of the event.

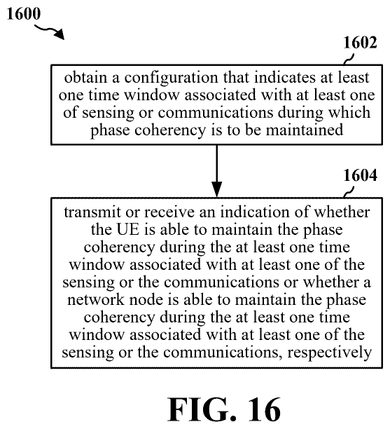

FIG. 16 is a flowchart 1600 of a method of wireless communication. The method may be performed by a UE (e.g., the UE 104, the UE 350, the UE 404, one of the UE 1206-1212, one of the UEs 1306-1312, the UE 1502, the apparatus 1804). The method may be associated with various advantages at the UE, such as the facilitation of JCS. In an example, the method (including the various aspects detailed below) may be performed by the phase coherence component 198.

At 1602, the UE obtains a configuration that indicates at least one time window associated with at least one of sensing or communications during which phase coherency is to be maintained. For example, FIG. 15 at 1506 shows that the UE 1502 may obtain a configuration that indicates time window(s) associated with sensing and/or communications during which phase coherency is to be maintained.

Maintaining phase coherency may include aspects described above in relation to FIG. 5. In an example, the at least one time window may be or include the periodic TDW 904, the aperiodic TDW 910, the phase coherence window 1006, the common TDW 1104, the first TDW 1114, the second TDW 1116, the first actual TDW 1406, the second actual TDW 1412, or the actual TDW 1416. In an example, the sensing may include aspects described above in connection with Table 2 above. In an example, the communications may be with a network node, such as the base station 1504. In an example, 1602 may be performed by the phase coherence component 198.

At 1604, the UE transmits or receives an indication of whether the UE is able to maintain the phase coherency during the at least one time window associated with at least one of the sensing or the communications or whether a network node is able to maintain the phase coherency during the at least one time window associated with at least one of the sensing or the communications, respectively. For example, FIG. 15 at 1510 shows that the UE 1502 may transmit an indication of whether the UE 1502 is able to maintain phase coherency during time window(s) associated with sensing and/or communications. For example, FIG. 15 at 1524 shows that the UE 1502 may receive an indication of whether the base station 1504 is able to maintain phase coherency during time window(s) associated with sensing and/or communications. In an example, 1604 may be performed by the phase coherence component 198.

In one aspect, the configuration may further indicate that the at least one time window is to be activated periodically. For example, the configuration may be for the periodic TDW 904 in the first example 902 depicted in FIG. 9.

In one aspect, the configuration may further indicate that the at least one time window is to be activated upon a reception of a DCI or a MAC-CE. For example, the configuration may be for the aperiodic TDW 910 in the second example 908 depicted in FIG. 9. In an example, the DCI or the MAC-CE may be the MAC-CE/DCI 912.

In one aspect, the at least one time window may include at least one TDW and a sensing measurement window, and the at least one TDW may occur within the sensing measurement window. For example, the at least one TDW may be the phase coherence window 1006 and the sensing measurement window may be the sensing measurement window 1004 as described in the first example 1002.

In one aspect, the at least one TDW may include a first TDW, and a plurality of reference signals may be transmitted or received during the first TDW while the phase coherency is maintained. For example, the first TDW may be the common TDW 1104 and the plurality of reference signals may be the S-RS 1106 and the SSB 1108. In another example, the plurality of reference signals may include aspects described above in connection with FIGS. 6-8.

In one aspect, the at least one TDW may include at least one first TDW and at least one second TDW, at least one first reference signal may be transmitted or received during the at least one first TDW, and at least one second reference signal may be transmitted or received during the at least one second TDW. For example, the at least one first TDW may be the first TDW 1114 and the at least one second TDW may be the second TDW 1116. In a further example in connection with FIG. 11, the S-RS 1106 may be transmitted or received in the first TDW 1114 and the SSB 1108 may be received in the second TDW 1116. In another example, the plurality of reference signals may include aspects described above in connection with FIGS. 6-8.

In one aspect, the configuration may further indicate that the UE is to measure at least one sensing reference signal during the at least one TDW, the indication may be a transmitted indication that indicates that the UE is able to maintain the phase coherency during the at least one TDW, and the UE may receive, from the network node, a second indication indicating that the UE is to measure the at least one sensing reference signal during the at least one TDW. For example, the configuration obtained at 1506 may indicate that the UE 1502 is to measure sensing reference signal(s) during TDW(s). In an example, the sensing reference signal(s) may include the S-RS 906, the S-RS 1106, or the S-RS 1408. In a further example, the indication may be the indication transmitted by the UE 1502 at 1510. Furthermore, FIG. 15 at 1512 shows that the UE 1502 may receive, from the base station 1504, an indication indicating that the UE 1502 is to measure sensing reference signal(s) during a TDW(s). In another example, receiving the second indication may include aspects described above in connection with FIG. 12.

In one aspect, the UE may measure the at least one sensing reference signal during the at least one TDW while the UE maintains the phase coherency based on receiving the second indication. For example, FIG. 15 at 1514 shows that the UE 1502 may measure sensing reference signal(s) during TDW(s) while the UE 1502 maintains phase coherency based on the UE 1502 receiving the indication at 1512. In another example, measuring the at least one sensing reference signal may include aspects described above in connection with FIG. 12.

In one aspect, the configuration may further indicate that the UE is to measure at least one sensing reference signal during the at least one TDW, the indication may be a transmitted indication that indicates that the UE is unable to maintain the phase coherency during the at least one TDW, and the UE may receive, from the network node and based on the transmitted indication, a second indication indicating that the network node has dropped a transmission of the at least one sensing reference signal or that resources associated with the transmission have been rescheduled. For example, the configuration obtained at 1506 may indicate that the UE 1502 is to measure sensing reference signal(s) during TDW(s). In an example, the sensing reference signal(s) may include the S-RS 906, the S-RS 1106, or the S-RS 1408. In a further example, the indication transmitted at 1510 may indicate that the UE 1502 is unable to maintain phase coherency during TDW(s). Furthermore, FIG. 15 at 1518 shows that the UE 1502 may receive an indication that the base station 1504 has dropped or rescheduled a transmission of sensing reference signal(s). In another example, receiving the second indication may include aspects described above in connection with FIG. 12.

In one aspect, the indication may be a transmitted indication that indicates a maximum duration during which the UE is able to maintain a transmission phase continuity, and the UE may receive, from the network node, a second indication of at least one length of the at least one TDW, where the at least one length of the at least one TDW may be less than or equal to the maximum duration. For example, the indication transmitted at 1510 may indicate a maximum duration during which the UE 1502 is able to maintain a transmission phase continuity (i.e., phase coherency). Furthermore, FIG. 15 at 1520 shows that the UE 1502 may receive an indication of length(s) of TDW(s), and the length(s) may be less than or equal to the maximum duration. In another example, receiving the second indication may include aspects described above in connection with FIG. 13.

In one aspect, the UE may transmit, for the network node, at least one sensing reference signal during the at least one TDW while the UE maintains the phase coherency, where the at least one TDW may have the at least one length. For example, FIG. 15 at 1522 shows that the UE 1502 may transmit, for the base station 1504, sensing reference signal(s) during TDW(s) that have the length(s). In another example, transmitting the at least one sensing reference signal during the at least one TDW while the UE maintains the phase coherency may include aspects described above in connection with FIG. 13.

In one aspect, the indication may be a received indication that indicates that the network node is able to maintain the phase coherency during the at least one TDW, and the UE may transmit, for the network node and based on the received indication, at least one sensing reference signal during the at least one TDW. For example, the indication received at 1524 may indicate that the base station 1504 is able to maintain phase coherency during TDW(s). Furthermore, FIG. 15 at 1526 shows that the UE 1502 may transmit sensing reference signal(s) during the TDW(s) based on the indication received at 1524. In another example, transmitting the at least one sensing reference signal may include aspects described above in connection with FIG. 13.

In one aspect, the indication may be a received indication that indicates that the network node is unable to maintain the phase coherency during the at least one TDW, and the UE may skip a transmission of at least one sensing reference signal based on the received indication. For example, the indication received at 1524 may indicate that the base station 1504 is unable to maintain phase coherency during TDW(s). Furthermore, FIG. 15 at 1528 shows that the UE 1502 may skip transmission of sensing reference signal(s) based on the indication received at 1524. In another example, skipping transmission of at least one reference signal based on the received indication may include aspects described above in connection with FIG. 13.

In one aspect, the indication may be a transmitted indication that indicates that the UE is unable to maintain the phase coherency during the at least one TDW due to an occurrence of at least one event, and the UE may generate an additional at least one TDW based on the occurrence of the at least one event. For example, the indication transmitted at 1510 may indicate that the UE 1502 is unable to maintain phase coherency during TDW(s) due to an occurrence of an event. Furthermore, FIG. 15 at 1530 shows that the UE 1502 may generate an additional TDW based on the occurrence of the event. In another example, generating the at least one additional TDW based on the occurrence of the event may include aspects described above in connection with the first example 1402 of FIG. 14. For instance, the event may be the event occurring at 1410, the at least one TDW may be the first actual TDW 1406, and the additional at least one TDW may be the second actual TDW 1412.

In one aspect, the UE may transmit at least one sensing reference signal during the additional at least one TDW while the UE maintains the phase coherency. For example, FIG. 15 at 1532 shows that the UE 1502 may transmit sensing reference signal(s) during an additional TDW while the UE 1502 maintains phase coherency. In another example, the at least one sensing reference signal may be the S-RS 1408 and the additional at least one TDW may be the second actual TDW 1412.

In one aspect, the indication may be a transmitted indication that indicates that the UE is unable to maintain the phase coherency during the at least one TDW due to an occurrence of at least one event, and the UE may skip a transmission of at least one sensing reference signal based on the occurrence of the at least one event. For example, the indication transmitted at 1510 may indicate that the UE 1502 is unable to maintain phase coherence during TDW(s) due to an occurrence of an event. Furthermore, FIG. 15 at 1534 shows that the UE 1502 may skip transmission of sensing reference signal(s) based on the occurrence of the event. In a further example, skipping the transmission of the at least one sensing reference signal based on the occurrence of the at least one event may include aspects described above in connection with the second example 1414 of FIG. 14.

In one aspect, the sensing may be one of UL sensing or DL sensing. For example, the sensing indicated by the configuration obtained at 1506 may be for UL sensing or DL sensing. In another example, the DL sensing may include aspects described above in connection with FIG. 12 and the UL sensing may include aspects described above in connection with FIG. 13.

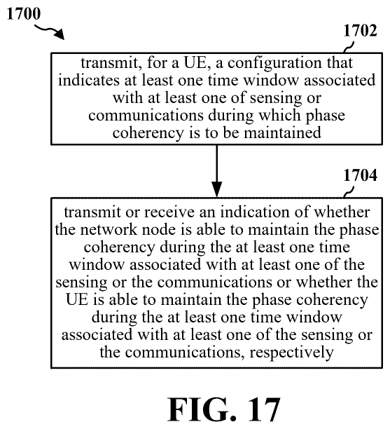

FIG. 17 is a flowchart 1700 of a method of wireless communication. The method may be performed by a network node (e.g., the base station 102, the base station 310, the base station 1204, the base station 1304, the base station 1504, the network entity 1802, the network entity 1902). The method may be associated with various advantages at the network node, such as the facilitation of JCS. In an example, the method (including the various aspects detailed below) may be performed by the phase coherence component 198.

At 1702, the network node transmits, for a UE, a configuration that indicates at least one time window associated with at least one of sensing or communications during which phase coherency is to be maintained. For example, FIG. 15 at 1508 shows that the base station 1504 may transmit, for the UE 1502, a configuration that indicates time window(s) associated with sensing and/or communications during which phase coherency is to be maintained. Maintaining phase coherency may include aspects described above in relation to FIG. 5. In an example, the at least one time window may be or include the periodic TDW 904, the aperiodic TDW 910, the phase coherence window 1006, the common TDW 1104, the first TDW 1114, the second TDW 1116, the first actual TDW 1406, the second actual TDW 1412, or the actual TDW 1416. In an example, the sensing may include aspects described above in connection with Table 2 above. In an example, 1702 may be performed by the phase coherence component 199.

At 1704, the network node transmits or receives an indication of whether the network node is able to maintain the phase coherency during the at least one time window associated with at least one of the sensing or the communications or whether the UE is able to maintain the phase coherency during the at least one time window associated with at least one of the sensing or the communications, respectively. For example, FIG. 15 at 1524 shows that the base station 1504 may transmit an indication of whether the base station 1504 is able to maintain phase coherency during time window(s) associated with sensing and/or communications. For example, FIG. 15 at 1510 shows that the base station 1504 may receive an indication of whether the UE 1502 is able to maintain phase coherency during time window(s) associated with sensing and/or communications. In an example, 1704 may be performed by the phase coherence component 199.

In one aspect, the configuration may further indicate that the at least one time window is to be activated periodically. For example, the configuration may be for the periodic TDW 904 in the first example 902 depicted in FIG. 9.

In one aspect, the configuration may further indicate that the at least one time window is to be activated upon a reception of DCI or a MAC-CE by the UE. For example, the configuration may be for the aperiodic TDW 910 in the second example 908 depicted in FIG. 9. In an example, the DCI or the MAC-CE may be the MAC-CE/DCI 912.

In one aspect, the at least one time window may include at least one TDW and a sensing measurement window, and the at least one TDW may occur within the sensing measurement window. For example, the at least one TDW may be the phase coherence window 1006 and the sensing measurement window may be the sensing measurement window 1004 as described in the first example 1002.

In one aspect, the at least one TDW may include a first TDW, and a plurality of reference signals may be transmitted or received during the first TDW while the phase coherency is maintained. For example, the first TDW may be the common TDW 1104 and the plurality of reference signals may be the S-RS 1106 and the SSB 1108. In another example, the plurality of reference signals may include aspects described above in connection with FIGS. 6-8.

In one aspect, the at least one TDW may include at least one first TDW and at least one second TDW, at least one first reference signal may be transmitted or received during the at least one first TDW, and at least one second reference signal may be transmitted or received during the at least one second TDW. For example, the at least one first TDW may be the first TDW 1114 and the at least one second TDW may be the second TDW 1116. In a further example in connection with FIG. 11, the S-RS 1106 may be transmitted or received in the first TDW 1114 and the SSB 1108 may be transmitted in the second TDW 1116. In another example, the plurality of reference signals may include aspects described above in connection with FIGS. 6-8.

In one aspect, the configuration may further indicate that the UE is to measure at least one sensing reference signal during the at least one TDW, the indication may be a received indication that indicates that the UE is able to maintain the phase coherency during the at least one TDW, and the network node may transmit, for the UE, a second indication indicating that the UE is to measure the at least one sensing reference signal during the at least one TDW. For example, the configuration transmitted at 1508 may indicate that the UE 1502 is to measure sensing reference signal(s) during TDW(s). Furthermore, the indication received at 1510 may indicate that the UE 1502 is able to maintain phase coherency during TDW(s). In an example, the sensing reference signal(s) may include the S-RS 906, the S-RS 1106, or the S-RS 1408. Furthermore, FIG. 15 at 1512 shows that the base station 1504 may transmit an indication indicating that the UE 1502 is to measure sensing reference signal(s) during the TDW(s). In another example, transmitting the second indication may include aspects described above in connection with FIG. 12.

In one aspect, the network node may receive, from the UE, at least one measurement of the at least one sensing reference signal based on transmitting the second indication. For example, FIG. 15 at 1516 shows that the base station 1504 may receive measurement(s) of sensing reference signal(s) based on the indication transmitted at 1512. In another example, receiving the at least one measurement may include aspects described above in connection with FIG. 12.

In one aspect, the configuration may further indicate that the UE is to measure at least one sensing reference signal during the at least one TDW, the indication may be a received indication that indicates that the UE is unable to maintain the phase coherency during the at least one TDW, and the network node may transmit, for the UE, a second indication indicating that a transmission of the at least one sensing reference signal has been dropped or that resources associated with the transmission have been rescheduled. For example, the configuration transmitted at 1508 may indicate that the UE 1502 is to measure sensing reference signal(s) during TDW(s). Furthermore, the indication received at 1510 may indicate that the UE 1502 is unable to maintain phase coherency during TDW(s). Additionally, FIG. 15 at 1518 shows that the base station 1504 may transmit an indication indicating that the base station 1504 has dropped or rescheduled transmission of sensing reference signal(s). In an example, the sensing reference signal(s) may include the S-RS 906, the S-RS 1106, or the S-RS 1408. In another example, transmitting the second indication may include aspects described above in connection with FIG. 12.

In one aspect, the indication may be a received indication that indicates a maximum duration during which the UE is able to maintain a transmission phase continuity, and the network node may transmit, for the UE, a second indication of at least one length of the at least one TDW, where the at least one length of the at least one TDW may be less than or equal to the maximum duration. For example, the indication received at 1510 may indicate a maximum duration during which the UE is able to maintain a transmission phase continuity (i.e., phase coherency). Furthermore, FIG. 15 at 1520 shows that the base station 1504 may transmit an indication of length(s) of TDW(s), and the length(s) may be less than or equal to the maximum duration. In another example, transmitting the second indication may include aspects described above in connection with FIG. 13.

In one aspect, the network node may receive, from the UE, at least one sensing reference signal during the at least one TDW, where the at least one TDW may have the at least one length. For example, FIG. 15 at 1522 shows that the base station 1504 may receive sensing reference signal(s) during TDW(s), where the TDW(s) have the length(s) indicated to the UE 1502 at 1520. In another example, receiving the at least one sensing reference signal may include aspects described above in connection with FIG. 13.

In one aspect, the indication may be a transmitted indication that indicates that the network node is able to maintain the phase coherency during the at least one TDW, and the network node may receive, from the UE and based on the transmitted indication, at least one sensing reference signal during the at least one TDW while the network node maintains the phase coherency. For example, the indication transmitted at 1524 may indicate that the base station 1504 is able to maintain phase coherency during TDW(s). Furthermore, FIG. 15 at 1526 shows that the base station 1504 may receive sensing reference signal(s) during TDW(s) while the base station 1504 maintains phase coherency during the TDW(s) based on the indication transmitted at 1524. In another example, receiving the at least one sensing reference signal may include aspects described above in connection with FIG. 13.

In one aspect, the indication may be a transmitted indication that indicates that the network node is unable to maintain the phase coherency during the at least one TDW. For example, the indication transmitted at 1524 may indicate that the base station 1504 is unable to maintain phase coherency during TDW(s).

In one aspect, the indication may be a received indication that indicates that the UE is unable to maintain the phase coherency during the at least one TDW due to an occurrence of at least one event, and the network node may receive at least one sensing reference signal during an additional at least one TDW based on the occurrence of the at least one event. For example, the indication received at 1510 may indicate that the UE 1502 is unable to maintain phase coherency during TDW(s) due to an occurrence of an event. Furthermore, FIG. 15 at 1532 shows that the base station 1504 may receive sensing reference signal(s) during an additional TDW(s). In another example, receiving the at least one sensing reference signal may include aspects described above in connection with the first example 1402 of FIG. 14. For instance, the event may be the event occurring at 1410, the at least one TDW may be the first actual TDW 1406, and the additional at least one TDW may be the second actual TDW 1412.

In one aspect, the indication may be a received indication that indicates that the UE is unable to maintain the phase coherency during the at least one TDW due to an occurrence of at least one event. For example, the indication received at 1510 may indicate that the UE 1502 is unable to maintain phase coherency during TDW(s) due to an occurrence of an event.

In one aspect, the sensing may be one of UL sensing or DL sensing. For example, the sensing indicated by the configuration obtained at 1506 may be for UL sensing or DL sensing. In another example, the DL sensing may include aspects described above in connection with FIG. 12 and the UL sensing may include aspects described above in connection with FIG. 13.

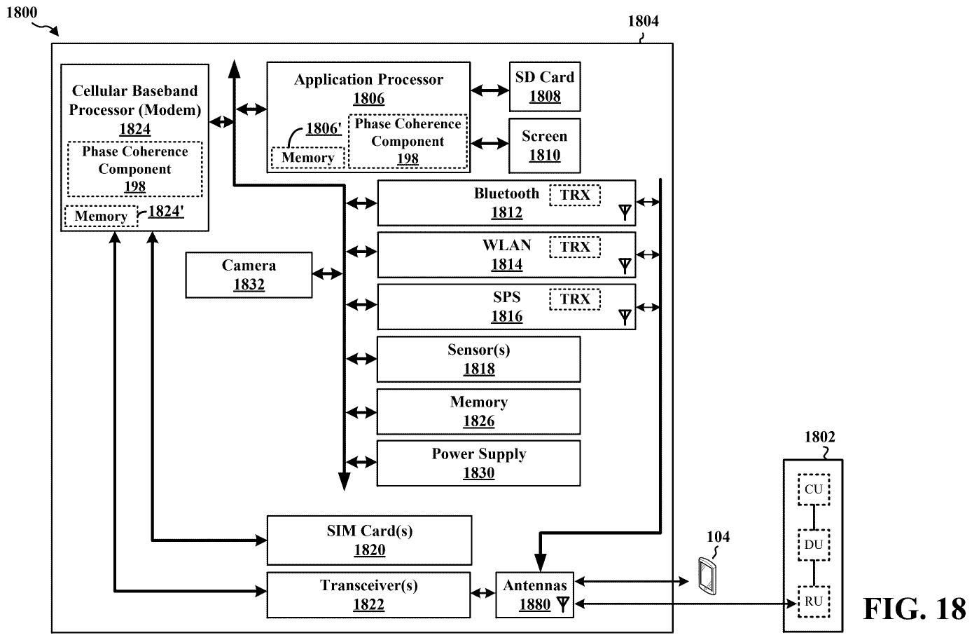

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see UE 350 of FIG. 3) and include the additional modules of the apparatus 1804.

As discussed supra, the phase coherence component 198 may be configured to obtain a configuration that indicates at least one time window associated with at least one of sensing or communications during which phase coherency is to be maintained. The phase coherence component 198 may be configured to transmit or receive an indication of whether the UE is able to maintain the phase coherency during the at least one time window associated with at least one of the sensing or the communications or whether a network node is able to maintain the phase coherency during the at least one time window associated with at least one of the sensing or the communications, respectively. The phase coherence component 198 may be configured to receive, from the network node, a second indication indicating that the UE is to measure the at least one sensing reference signal during the at least one TDW. The phase coherence component 198 may be configured to measure the at least one sensing reference signal during the at least one TDW while the UE maintains the phase coherency based on a reception of the second indication. The phase coherence component 198 may be configured to receive, from the network node and based on the transmitted indication, a second indication indicating that the network node has dropped a transmission of the at least one sensing reference signal or that resources associated with the transmission have been rescheduled. The phase coherence component 198 may be configured to receive, from the network node, a second indication of at least one length of the at least one TDW, where the at least one length of the at least one TDW is less than or equal to the maximum duration. The phase coherence component 198 may be configured to transmit, for the network node, at least one sensing reference signal during the at least one TDW while the UE maintains the phase coherency, where the at least one TDW has the at least one length. The phase coherence component 198 may be configured to transmit, for the network node and based on the received indication, at least one sensing reference signal during the at least one TDW. The phase coherence component 198 may be configured to skip a transmission of at least one sensing reference signal based on the received indication. The phase coherence component 198 may be configured to generate an additional at least one TDW based on the occurrence of the at least one event. The phase coherence component 198 may be configured to transmit at least one sensing reference signal during the additional at least one TDW while the UE maintains the phase coherency. The phase coherence component 198 may be configured to skip a transmission of at least one sensing reference signal based on the occurrence of the at least one event. The phase coherence component 198 may be within the cellular baseband processor 1824, the application processor 1806, or both the cellular baseband processor 1824 and the application processor 1806. The phase coherence component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, may include means for obtaining a configuration that indicates at least one time window associated with at least one of sensing or communications during which phase coherency is to be maintained. In one configuration, the apparatus 1804, and in particular the cellular baseband processor 1824 and/or the application processor 1806, may include means for transmitting or receiving an indication of whether the UE is able to maintain the phase coherency during the at least one time window associated with at least one of the sensing or the communications or whether a network node is able to maintain the phase coherency during the at least one time window associated with at least one of the sensing or the communications, respectively. In one configuration, the apparatus 1804, and in particular the cellular baseband processor 1824 and/or the application processor 1806, may include means for receiving, from the network node, a second indication indicating that the UE is to measure the at least one sensing reference signal during the at least one TDW. In one configuration, the apparatus 1804, and in particular the cellular baseband processor 1824 and/or the application processor 1806, may include means for measuring the at least one sensing reference signal during the at least one TDW while the UE maintains the phase coherency based on receiving the second indication. In one configuration, the apparatus 1804, and in particular the cellular baseband processor 1824 and/or the application processor 1806, may include means for receiving, from the network node and based on the transmitted indication, a second indication indicating that the network node has dropped a transmission of the at least one sensing reference signal or that resources associated with the transmission have been rescheduled. In one configuration, the apparatus 1804, and in particular the cellular baseband processor 1824 and/or the application processor 1806, may include means for receiving, from the network node, a second indication of at least one length of the at least one TDW, where the at least one length of the at least one TDW is less than or equal to the maximum duration. In one configuration, the apparatus 1804, and in particular the cellular baseband processor 1824 and/or the application processor 1806, may include means for transmitting, for the network node, at least one sensing reference signal during the at least one TDW while the UE maintains the phase coherency, where the at least one TDW has the at least one length. In one configuration, the apparatus 1804, and in particular the cellular baseband processor 1824 and/or the application processor 1806, may include means for transmitting, for the network node and based on the received indication, at least one sensing reference signal during the at least one TDW. In one configuration, the apparatus 1804, and in particular the cellular baseband processor 1824 and/or the application processor 1806, may include means for skipping a transmission of at least one sensing reference signal based on the received indication. In one configuration, the apparatus 1804, and in particular the cellular baseband processor 1824 and/or the application processor 1806, may include means for generating an additional at least one TDW based on the occurrence of the at least one event. In one configuration, the apparatus 1804, and in particular the cellular baseband processor 1824 and/or the application processor 1806, may include means for transmitting at least one sensing reference signal during the additional at least one TDW while the UE maintains the phase coherency. In one configuration, the apparatus 1804, and in particular the cellular baseband processor 1824 and/or the application processor 1806, may include means for skipping a transmission of at least one sensing reference signal based on the occurrence of the at least one event. The means may be the phase coherence component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

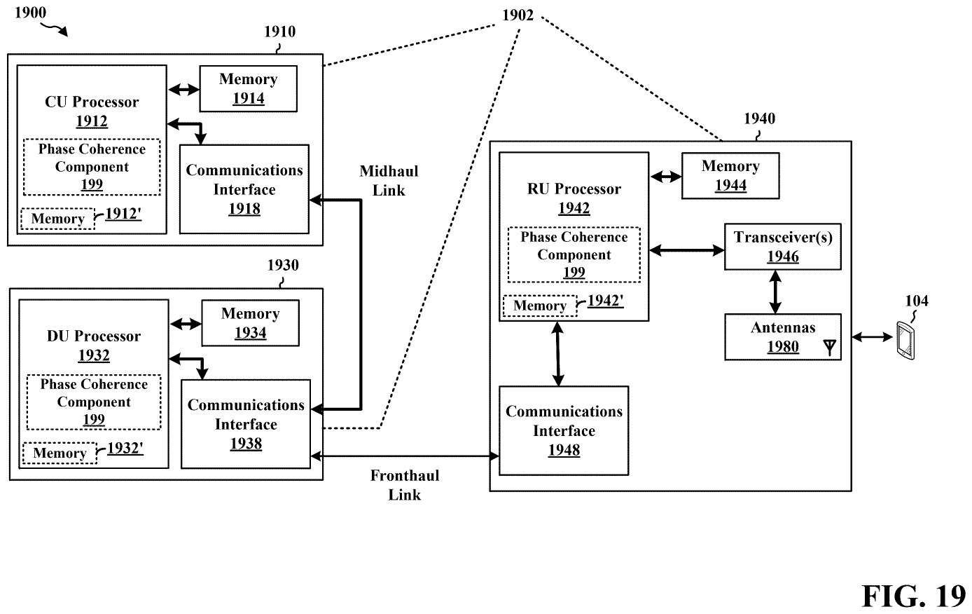

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the phase coherence component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the phase coherence component 199 may be configured to transmit, for a UE, a configuration that indicates at least one time window associated with at least one of sensing or communications during which phase coherency is to be maintained. The phase coherence component 199 may be configured to transmit or receive an indication of whether the network node is able to maintain the phase coherency during the at least one time window associated with at least one of the sensing or the communications or whether the UE is able to maintain the phase coherency during the at least one time window associated with at least one of the sensing or the communications, respectively. The phase coherence component 199 may be configured to transmit, for the UE, a second indication indicating that the UE is to measure the at least one sensing reference signal during the at least one TDW. The phase coherence component 199 may be configured to receive, from the UE, at least one measurement of the at least one sensing reference signal based on a transmission of the second indication. The phase coherence component 199 may be configured to transmit, for the UE, a second indication indicating that a transmission of the at least one sensing reference signal has been dropped or that resources associated with the transmission have been rescheduled. The phase coherence component 199 may be configured to transmit, for the UE, a second indication of at least one length of the at least one TDW, where the at least one length of the at least one TDW is less than or equal to the maximum duration. The phase coherence component 199 may be configured to receive, from the UE, at least one sensing reference signal during the at least one TDW, where the at least one TDW has the at least one length. The phase coherence component 199 may be configured to receive, from the UE and based on the transmitted indication, at least one sensing reference signal during the at least one TDW while the network node maintains the phase coherency. The phase coherence component 199 may be configured to receive at least one sensing reference signal during an additional at least one TDW based on the occurrence of the at least one event. The phase coherence component 199 may be within one or more processors of one or more of the CU 1910, DU 1930, and the RU 1940. The phase coherence component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 may include means for transmitting, for a UE, a configuration that indicates at least one time window associated with at least one of sensing or communications during which phase coherency is to be maintained. In one configuration, the network entity 1902 may include means for transmitting or receiving an indication of whether the network node is able to maintain the phase coherency during the at least one time window associated with at least one of the sensing or the communications or whether the UE is able to maintain the phase coherency during the at least one time window associated with at least one of the sensing or the communications, respectively. In one configuration, the network entity 1902 may include means for transmitting, for the UE, a second indication indicating that the UE is to measure the at least one sensing reference signal during the at least one TDW. In one configuration, the network entity 1902 may include means for receiving, from the UE, at least one measurement of the at least one sensing reference signal based on transmitting the second indication. In one configuration, the network entity 1902 may include means for transmitting, for the UE, a second indication indicating that a transmission of the at least one sensing reference signal has been dropped or that resources associated with the transmission have been rescheduled. In one configuration, the network entity 1902 may include means for transmitting, for the UE, a second indication of at least one length of the at least one TDW, where the at least one length of the at least one TDW is less than or equal to the maximum duration. In one configuration, the network entity 1902 may include means for receiving, from the UE, at least one sensing reference signal during the at least one TDW, where the at least one TDW has the at least one length. In one configuration, the network entity 1902 may include means for receiving, from the UE and based on the transmitted indication, at least one sensing reference signal during the at least one TDW while the network node maintains the phase coherency. In one configuration, the network entity 1902 may include means for receiving at least one sensing reference signal during an additional at least one TDW based on the occurrence of the at least one event. The means may be the phase coherence component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

As discussed above, a wireless communication system may include JCS capabilities. JCS may refer to an ability of the wireless communication system to perform both wireless communications and sensing (e.g., radar sensing, radio frequency (RF) sensing) simultaneously. For instance, a wireless device equipped with JCS capability may perform sensing to determine aspects of an environment around the wireless device while also communicating with another wireless device (e.g., a base station). A wireless device (e.g., a UE, a base station etc.) may maintain phase continuity in order to perform sensing. If phase continuity is not maintained, sensing performed by the wireless device may be inaccurate.

Various technologies pertaining to a time domain window (TDW) for radar reference signal transmission to indicate phase coherency are described herein. The TDW may be a phase coherence TDW for network based DL sensing. The TDW may be configured to recur periodically or the TDW may be configured to occur dynamically. A sensing reference signal (S-RS) dropping rule may be based on Tx and Rx phase coherence capability reporting. The TDW may be a phase coherence TDW for UE based UL sensing. The TDW may be configured to accommodate an event that violates Tx phase coherence.

In an example, a UE obtains a configuration that indicates at least one time window associated with at least one of sensing or communications during which phase coherency is to be maintained. The UE transmits or receives an indication of whether the UE is able to maintain the phase coherency during the at least one time window associated with at least one of the sensing or the communications or whether a network node is able to maintain the phase coherency during the at least one time window associated with at least one of the sensing or the communications, respectively. Vis-à-vis transmitting an indication of whether the UE is able to maintain phase coherency during the at least one time window associated with at least one of the sensing or the communications or whether the network node is able to maintain phase coherency during the at least one time window associated with at least one of the sensing or the communication, the UE and/or the network node may perform subsequent actions that facilitate JCS. For instance, if the UE is unable to maintain phase coherency during a time window, a network node may skip a transmission of a sensing reference signal during the time window, as a measurement performed on the sensing reference signal may not be accurate due to phase coherency not being maintained.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: obtaining a configuration that indicates at least one time window associated with at least one of sensing or communications during which phase coherency is to be maintained; and transmitting or receiving an indication of whether the UE is able to maintain the phase coherency during the at least one time window associated with at least one of the sensing or the communications or whether a network node is able to maintain the phase coherency during the at least one time window associated with at least one of the sensing or the communications, respectively.

Aspect 2 is the method of aspect 1, where the configuration further indicates that the at least one time window is to be activated periodically.

Aspect 3 is the method of any of aspects 1-2, where the configuration further indicates that the at least one time window is to be activated upon receiving DCI or a MAC-CE.

Aspect 4 is the method of any of aspects 1-3, where the at least one time window includes at least one TDW and a sensing measurement window, and where the at least one TDW occurs within the sensing measurement window.

Aspect 5 is the method of aspect 4, where the at least one TDW includes a first TDW, and where a plurality of reference signals is transmitted or received during the first TDW while the phase coherency is maintained.

Aspect 6 is the method of aspect 4, where the at least one TDW includes at least one first TDW and at least one second TDW, where at least one first reference signal is transmitted or received during the at least one first TDW, and where at least one second reference signal is transmitted or received during the at least one second TDW.

Aspect 7 is the method of any of aspects 4-6, where the configuration further indicates that the UE is to measure at least one sensing reference signal during the at least one TDW, where the indication is a transmitted indication that indicates that the UE is able to maintain the phase coherency during the at least one TDW, the method further including: receiving, from the network node, a second indication indicating that the UE is to measure the at least one sensing reference signal during the at least one TDW; and measuring the at least one sensing reference signal during the at least one TDW while the UE maintains the phase coherency based on receiving the second indication.

Aspect 8 is the method of any of aspects 4-6, where the configuration further indicates that the UE is to measure at least one sensing reference signal during the at least one TDW, where the indication is a transmitted indication that indicates that the UE is unable to maintain the phase coherency during the at least one TDW, the method further including: receiving, from the network node and based on the transmitted indication, a second indication indicating that the network node has dropped a transmission of the at least one sensing reference signal or that resources associated with the transmission have been rescheduled.

Aspect 9 is the method of any of aspects 4-8, where the indication is a transmitted indication that indicates a maximum duration during which the UE is able to maintain a transmission phase continuity, the method further including: receiving, from the network node, a second indication of at least one length of the at least one TDW, where the at least one length of the at least one TDW is less than or equal to the maximum duration; and transmitting, for the network node, at least one sensing reference signal during the at least one TDW while the UE maintains the phase coherency, where the at least one TDW has the at least one length.

Aspect 10 is the method of any of aspects 4-6, where the indication is a received indication that indicates that the network node is able to maintain the phase coherency during the at least one TDW, the method further including: transmitting, for the network node and based on the received indication, at least one sensing reference signal during the at least one TDW.

Aspect 11 is the method of any of aspects 4-6, where the indication is a received indication that indicates that the network node is unable to maintain the phase coherency during the at least one TDW, the method further including: skipping a transmission of at least one sensing reference signal based on the received indication.

Aspect 12 is the method of any of aspects 4-6, where the indication is a transmitted indication that indicates that the UE is unable to maintain the phase coherency during the at least one TDW due to an occurrence of at least one event, the method further including: generating an additional at least one TDW based on the occurrence of the at least one event; and transmitting at least one sensing reference signal during the additional at least one TDW while the UE maintains the phase coherency.

Aspect 13 is the method of any of aspects 4-6, where the indication is a transmitted indication that indicates that the UE is unable to maintain the phase coherency during the at least one TDW due to an occurrence of at least one event, the method further including: skipping a transmission of at least one sensing reference signal based on the occurrence of the at least one event.

Aspect 14 is the method of any of aspects 1-13, where the sensing is one of UL sensing or DL sensing.

Aspect 15 is an apparatus for wireless communication at a UE including a memory and at least one processor coupled to the memory and based at least in part on information stored in the memory, the at least one processor is configured to perform a method in accordance with any of aspects 1-14.

Aspect 16 is an apparatus for wireless communications, including means for performing a method in accordance with any of aspects 1-14.

Aspect 17 is the apparatus of aspect 15 or 16 further including at least one of an antenna or a transceiver coupled to the at least one processor, where the at least one processor is configured to transmit or receive the indication via at least one of the antenna or the transceiver.

Aspect 18 is a computer-readable medium (e.g., a non-transitory computer-readable medium) including instructions that, when executed by an apparatus, cause the apparatus to perform a method in accordance with any of aspects 1-14.

Aspect 19 is a method of wireless communication at a network node, including: transmitting, for a UE, a configuration that indicates at least one time window associated with at least one of sensing or communications during which phase coherency is to be maintained; and transmitting or receiving an indication of whether the network node is able to maintain the phase coherency during the at least one time window associated with at least one of the sensing or the communications or whether the UE is able to maintain the phase coherency during the at least one time window associated with at least one of the sensing or the communications, respectively.

Aspect 20 is the method of aspect 19, where the configuration further indicates that the at least one time window is to be activated periodically.

Aspect 21 is the method of any of aspects 19-20, where the configuration further indicates that the at least one time window is to be activated upon a reception of DCI or a MAC-CE by the UE.

Aspect 22 is the method of any of aspects 19-21, where the at least one time window includes at least one TDW and a sensing measurement window, and where the at least one TDW occurs within the sensing measurement window.

Aspect 23 is the method of aspect 22, where the at least one TDW includes a first TDW, and where a plurality of reference signals is transmitted or received during the first TDW while the phase coherency is maintained.

Aspect 24 is the method of aspect 22, where the at least one TDW includes at least one first TDW and at least one second TDW, where at least one first reference signal is transmitted or received during the at least one first TDW, and where at least one second reference signal is transmitted or received during the at least one second TDW.

Aspect 25 is the method of any of aspects 22-24, where the configuration further indicates that the UE is to measure at least one sensing reference signal during the at least one TDW, where the indication is a received indication that indicates that the UE is able to maintain the phase coherency during the at least one TDW, the method further including: transmitting, for the UE, a second indication indicating that the UE is to measure the at least one sensing reference signal during the at least one TDW; and receiving, from the UE, at least one measurement of the at least one sensing reference signal based on transmitting the second indication.

Aspect 26 is the method of any of aspects 22-24, where the configuration further indicates that the UE is to measure at least one sensing reference signal during the at least one TDW, where the indication is a received indication that indicates that the UE is unable to maintain the phase coherency during the at least one TDW, the method further including: transmitting, for the UE, a second indication indicating that a transmission of the at least one sensing reference signal has been dropped or that resources associated with the transmission have been rescheduled.

Aspect 27 is the method of any of aspects 22-24, where the indication is a received indication that indicates a maximum duration during which the UE is able to maintain a transmission phase continuity, the method further including: transmitting, for the UE, a second indication of at least one length of the at least one TDW, where the at least one length of the at least one TDW is less than or equal to the maximum duration; and receiving, from the UE, at least one sensing reference signal during the at least one TDW, where the at least one TDW has the at least one length.

Aspect 28 is the method of any of aspects 22-24, where the indication is a transmitted indication that indicates that the network node is able to maintain the phase coherency during the at least one TDW, the method further including: receiving, from the UE and based on the transmitted indication, at least one sensing reference signal during the at least one TDW while the network node maintains the phase coherency.

Aspect 29 is the method of any of aspects 22-24, where the indication is a transmitted indication that indicates that the network node is unable to maintain the phase coherency during the at least one TDW.

Aspect 30 is the method of any of aspects 22-24, where the indication is a received indication that indicates that the UE is unable to maintain the phase coherency during the at least one TDW due to an occurrence of at least one event, the method further including: receiving at least one sensing reference signal during an additional at least one TDW based on the occurrence of the at least one event.

Aspect 31 is the method of any of aspects 22-24, where the indication is a received indication that indicates that the UE is unable to maintain the phase coherency during the at least one TDW due to an occurrence of at least one event.

Aspect 32 is the method of any of aspects 19-31, where the sensing is one of UL sensing or DL sensing.

Aspect 33 is an apparatus for wireless communication at a network node including a memory and at least one processor coupled to the memory and based at least in part on information stored in the memory, the at least one processor is configured to perform a method in accordance with any of aspects 19-32.

Aspect 34 is an apparatus for wireless communications, including means for performing a method in accordance with any of aspects 19-32.

Aspect 35 is the apparatus of aspect 33 or 34 further including at least one of an antenna or a transceiver coupled to the at least one processor, where the at least one processor is configured to transmit or receive the indication via at least one of the antenna or the transceiver.

Aspect 36 is a computer-readable medium (e.g., a non-transitory computer-readable medium) including instructions that, when executed by an apparatus, cause the apparatus to perform a method in accordance with any of aspects 19-32.

1. An apparatus for wireless communication at a user equipment (UE), comprising:
a memory; and
at least one processor coupled to the memory and, based at least in part on information stored in the memory, the at least one processor is configured to:
obtain a configuration that indicates at least one time window associated with at least one of sensing or communications during which phase coherency is to be maintained; and
transmit or receive an indication of whether the UE is able to maintain the phase coherency during the at least one time window associated with at least one of the sensing or the communications or whether a network node is able to maintain the phase coherency during the at least one time window associated with at least one of the sensing or the communications, respectively.

2. The apparatus of claim 1, wherein the configuration further indicates that the at least one time window is configured to be activated periodically.

3. The apparatus of claim 1, wherein the configuration further indicates that the at least one time window is configured to be activated upon a reception of a downlink control information (DCI) or a medium access control (MAC) control element (MAC-CE).

4. The apparatus of claim 1, wherein the at least one time window comprises at least one time domain window (TDW) and a sensing measurement window, and wherein the at least one TDW occurs within the sensing measurement window.

5. The apparatus of claim 4, wherein the at least one TDW comprises a first TDW, and wherein the at least one processor is configured to transmit or receive a plurality of reference signals during the first TDW while the phase coherency is maintained.

6. The apparatus of claim 4, wherein the at least one TDW comprises at least one first TDW and at least one second TDW, wherein the at least one processor is configured to transmit or receive at least one first reference signal during the at least one first TDW, and wherein the at least one processor is configured to transmit or receive at least one second reference signal during the at least one second TDW.

7. The apparatus of claim 4, wherein the configuration further indicates that the UE is to measure at least one sensing reference signal during the at least one TDW, wherein the indication is a transmitted indication that indicates that the UE is able to maintain the phase coherency during the at least one TDW, wherein the at least one processor is further configured to:
receive, from the network node, a second indication that indicates that the UE is to measure the at least one sensing reference signal during the at least one TDW; and
measure the at least one sensing reference signal during the at least one TDW while the UE is configured to maintain the phase coherency based on a reception of the second indication.

8. The apparatus of claim 4, wherein the configuration further indicates that the UE is to measure at least one sensing reference signal during the at least one TDW, wherein the indication is a transmitted indication that indicates that the UE is unable to maintain the phase coherency during the at least one TDW, wherein the at least one processor is further configured to:
receive, from the network node and based on the transmitted indication, a second indication that indicates that the network node has dropped a transmission of the at least one sensing reference signal or that resources associated with the transmission have been rescheduled.

9. The apparatus of claim 4, wherein the indication is a transmitted indication that indicates a maximum duration during which the UE is able to maintain a transmission phase continuity, wherein the at least one processor is further configured to:
receive, from the network node, a second indication of at least one length of the at least one TDW, wherein the at least one length of the at least one TDW is less than or equal to the maximum duration; and
transmit, for the network node, at least one sensing reference signal during the at least one TDW while the UE is configured to maintain the phase coherency, wherein the at least one TDW has the at least one length.

10. The apparatus of claim 4, wherein the indication is a received indication that indicates that the network node is able to maintain the phase coherency during the at least one TDW, wherein the at least one processor is further configured to:
transmit, for the network node and based on the received indication, at least one sensing reference signal during the at least one TDW.

11. The apparatus of claim 4, wherein the indication is a received indication that indicates that the network node is unable to maintain the phase coherency during the at least one TDW, wherein the at least one processor is further configured to:
skip a transmission of at least one sensing reference signal based on the received indication.

12. The apparatus of claim 4, wherein the indication is a transmitted indication that indicates that the UE is unable to maintain the phase coherency during the at least one TDW due to an occurrence of at least one event, wherein the at least one processor is further configured to:
generate an additional at least one TDW based on the occurrence of the at least one event, and
transmit at least one sensing reference signal during the additional at least one TDW while the UE is configured to maintain the phase coherency.

13. The apparatus of claim 4, wherein the indication is a transmitted indication that indicates that the UE is unable to maintain the phase coherency during the at least one TDW due to an occurrence of at least one event, wherein the at least one processor is further configured to:
skip a transmission of at least one sensing reference signal based on the occurrence of the at least one event.

14. The apparatus of claim 1, wherein the sensing is one of uplink (UL) sensing or downlink (DL) sensing.

15. The apparatus of claim 1, further comprising at least one of an antenna or a transceiver coupled to the at least one processor,
wherein to transmit or receive the indication, the at least one processor is configured to transmit or receive the indication via at least one of the antenna or the transceiver.

16-28. (canceled)

29. A method of wireless communication at a user equipment (UE), comprising:
obtaining a configuration that indicates at least one time window associated with at least one of sensing or communications during which phase coherency is to be maintained; and
transmitting or receiving an indication of whether the UE is able to maintain the phase coherency during the at least one time window associated with at least one of the sensing or the communications or whether a network node is able to maintain the phase coherency during the at least one time window associated with at least one of the sensing or the communications, respectively.

30. A method of wireless communication at a network node, comprising:
transmitting, for a user equipment (UE), a configuration that indicates at least one time window associated with at least one of sensing or communications during which phase coherency is to be maintained; and
transmitting or receiving an indication of whether the network node is able to maintain the phase coherency during the at least one time window associated with at least one of the sensing or the communications or whether the UE is able to maintain the phase coherency during the at least one time window associated with at least one of the sensing or the communications, respectively.
